(19) United States
(12) Patent Application Publication
(10) Pub. No.: US 2024/0185320 A1
(43) Pub. Date: Jun. 6, 2024

(54) SYSTEM, METHOD AND INTERFACE FOR GENERATING OR MODIFYING GARMENT PATTERNS

(71) Applicant: LULULEMON ATHLETICA CANADA INC., Vancouver (CA)

(72) Inventors: Mary Emma HUTCHINGS NAGLE, Vancouver (CA); Sharon Elizabeth JAMISON, Vancouver (CA); Philip David SIWEK, Vancouver (CA); Tyler Daniel CHUANG, Vancouver (CA); Joseph John SANTRY, Vancouver (CA); Miguel Angel HERRERA MACIAS, Vancouver (CA)

(21) Appl. No.: 18/550,636

(22) PCT Filed: Mar. 16, 2022
(86) PCT No.: PCT/CA2022/050397

§ 371 Date: Sep. 14, 2023

Related U.S. Application Data
(60) Provisional application No. 63/162,877, filed on Mar. 18, 2021.

(51) Int. Cl. G06Q 30/0601; G06F 30/17; G06F 111/16; G06F 113/12

(52) U.S. Cl. CPC G06Q 30/0621; G06F 30/17; G06F 2111/16; G06F 2113/12

(57) ABSTRACT

There is described a system for providing an interface for product personalization by generating or modifying garment patterns and associated code files. The system processes the extracted measurement attributes and user preferences using generative design models and customization data from a control panel of tools at the interface. The system involves an interface to display a visualization of a garment and uses output of a modeling system to support the visualization. The interface has the control panel of tools to customize, modify or generate garment patterns and associated code files.

### FIELD

The present disclosure relates generally to the field of computing, and in particular, to methods and systems for an interface for products and/or services. The methods and systems involve processing sensor data defining user measurement attributes and collected user preference data and generating or modifying computer models and garment patterns for personalization of products, such as apparel. The methods and systems involve an interface for input of sensor data for user measurements and interaction with sensors. The interface can have tools for the personalization of the garment patterns and materials for the garments, for example.

### INTRODUCTION

Embodiments described herein relate to automated systems for personalization of products and/or services that can involve different information capture technology, including invasive and non-invasive sensors. In an aspect, embodiments described herein involve automated systems for providing an interface for personalization of garment patterns and computer models representing garments by processing data captured by different information capture devices, such as sensors. In an aspect, embodiments described herein involve configuring material using interface tools and generating personalized products based on the garment patterns and computer models. The interface tools can enable the personalization of garment patterns and material based on computer models, and generating customized products based on sensor data, user data, garment designs, material configuration and the computer models.

### SUMMARY

Embodiments relate to methods and systems with non-transitory memory storing data records for generating or modifying patterns for products. An example product is a garment, such as a shirt, pants, jacket, bra, underwear, and so on. The patterns can be garment patterns, or patterns for pieces of garments, for example.

Embodiments relate to a system with non-transitory memory storing a database of pattern records, user records, including measurement attributes from sensor data and user preference data, material records. The user preference data includes different types of user data, such as activity preference, fit preference, feel preference, and so on. These preferences are combined with the user's physical ‘sensor data’ to drive the parametric data. User data includes both user preferences and users physical data (e.g. captured by sensors). The system has a hardware processor programmed with executable instructions for an interface having a control panel of tools with parameter controls for a parametric pattern to receive customization data to generate or modify a garment pattern. The pattern can be populated with parametric data generated from the user preference data. The interface displays a visualization of the garment pattern generated or modified by the control panel of tools with parameter controls for the parametric pattern. The system has a hardware server coupled to the memory to access the database. The hardware server is programmed with executable instructions to: extract measurement and movement attributes from the sensor data, and collect user preference data, to populate the user records in the database; generate or modify the garment pattern and associated code files by processing the extracted measurement and movement attributes, user preference data, and the customization data from interface having the control panel of tools with the parameter controls for the parametric pattern using the pattern records, the garment pattern and associated code files defining a perimeter pattern and a geometry (or mesh) of objects within the perimeter pattern; trigger the display of the visualization of the garment pattern at the interface using the associated code files and output of a modeling system; receive additional customization data from the interface having the control panel of tools with the parameter controls for the parametric pattern; modify the garment pattern and the associated code files using the additional customization data from the interface having the control panel of tools with the parameter controls for the parametric pattern; trigger the update of the display of the visualization of the garment pattern at the interface in response to modification of the garment pattern and the associated code files using the additional customization data from the interface having the control panel of tools with the parameter controls for the parametric pattern; a user device comprising one or more sensors for capturing the sensor data for the user, and a transmitter for transmitting the captured sensor data to the interface of the hardware processor or the hardware server over the network to personalize the product. An example product is a garment, such as a shirt, pants, jacket, bra, underwear, and so on.

In some embodiments, the control panel of tools with the parameter controls for the parametric pattern comprises gradient parameter controls for modifying gradient parameters for the parametric pattern.

In some embodiments, the control panel of tools with the parameter controls for the parametric pattern comprises attractor curve parameter controls for modifying attractor curve parameters for the parametric pattern.

In some embodiments, the control panel of tools with the parameter controls for the parametric pattern comprises pattern parameter controls for modifying pattern parameters for the parametric pattern.

In some embodiments, the control panel of tools with the parameter controls for the parametric pattern comprises preview parameter controls for modifying preview parameters for the parametric pattern.

In some embodiments, the garment pattern is for a bra, wherein the user data includes breast movement data, and the extracted measurement and movement attributes comprise side to side acceleration, up and down acceleration, displacement and angle of peak acceleration.

In some embodiments, the sensor data includes breast sensor data, and the hardware processor calibrates and filters signals from the breast sensor data and detects peaks and strides in the signals.

In some embodiments, the measurement and movement attributes comprise magnitude, resultant, resultant angle, wherein the hardware processors uses the magnitude to compute gradient metrics, uses the resultant to select movement group for a support pattern, and uses the resultant angle to apply gradient support.

In some embodiments, the hardware processor computes the gradient metrics using the user preference data.

In some embodiments, the hardware processor computes a baseline gradient using a product pattern piece, and a final gradient using the baseline gradient, the gradient metrics, the gradient support, and the support pattern.

In some embodiments, the garment pattern is for a pants, wherein the user data includes leg region movement data, and the extracted measurement and movement attributes comprise side to side acceleration, up and down acceleration, displacement and angle of peak acceleration for objects in the leg region.

In some embodiments, the user data includes movement data captured by the sensors, and the extracted measurement and movement attributes comprise side to side acceleration, up and down acceleration, displacement and angle of peak acceleration.

In some embodiments, the hardware server generates or modifies the garment pattern and the associated code files using the pattern records by selecting a base pattern for the garment and a base gradient, and optimizing the base pattern for the garment and the base gradient for a desired outcome.

In some embodiments, the hardware server generates or modifies the garment pattern and the associated code files using the pattern records by adjusting the base pattern for the garment and the base gradient using the extracted measurement and movement attributes and user preference data.

In some embodiments, the control panel of tools with the parameter controls for the parametric pattern comprises shape, size, falloff rate and interaction parameter controls, wherein the hardware server generates or modifies the garment pattern and the associated code files using the pattern records by selecting a base pattern for the garment and a base gradient, and optimizing the base pattern for the garment and the base gradient for a desired outcome by optimizing shape, size, falloff rate and interaction parameters based on input from the shape, size, falloff rate and interaction parameter controls.

In some embodiments, the hardware server generates or selects a base pattern using generative design models processing the user data, the base pattern for generating or modifying the garment.

In some embodiments, the hardware server transmits manufacturing instructions for the product in response to receiving purchase instructions at the interface.

In some embodiments, the hardware server updates the generative design models based on feedback data on the product;

In some embodiments, the hardware server generates the product and associated code files by generating bill of material files.

In some embodiments, the hardware server generates the product and associated code files by assembling content files.

In some embodiments, the interface receives a modification request for the product and wherein the hardware server updates the product and the associated code files based on the modification request.

In some embodiments, the user device captures the sensor data from a plurality of data sources, the sensor data defining physical or behavioural characteristics of the user by video data or audio data.

In some embodiments, the hardware server generates measurement metrics using at least one of 3D scanning, machine learning prediction, user measuring, and garment measuring.

In some embodiments, the hardware server generates movement metrics based inertial measurement unit (IMU) data, computer vision, pressure data, and radio-frequency data.

In some embodiments, the hardware server extracts the user attributes from user data comprising at least one of purchase history, activity intent, interaction history, and review data for the user.

In some embodiments, the hardware server generates perceptual preference metrics based on at least one of garment sensation, preferred handfeel, thermal preference, and movement sensation.

In some embodiments, the hardware server generates emotional signature metrics based on at least one of personality data, mood state data, emotional fitness data, personal values data, goals data, and physiological data, wherein the emotional signature metrics comprise social signature metrics, connectedness metrics, or resonance signature metrics, wherein the server selects a base pattern or the garment using the emotional signature metrics.

In some embodiments, the hardware processor computes a preferred sensory state as part of extracted user attributes.

In some embodiments, the user device connects to or integrates with an immersive hardware device that captures audio data, the image data and data defining physical or behavioural characteristics of the user as of the sensor data.

In some embodiments, the attributable database comprises simulated garment records, wherein the hardware server generates simulated product options as part of the product and associated code files, and wherein the interface displays a visualization of the simulated product options.

In some embodiments, the simulated product options comprise at least one of soft body physics simulation, hard body physics simulation, static 3D viewer and AR/VR experience content.

In some embodiments, the hardware server is configured to determine an emotional signature of one or more additional users; determine users with similar emotional signatures; predict connectedness between users with similar emotional signatures; and generate the product using data corresponding to the users with similar emotional signatures.

In some embodiments, the interface can transmit another product request, and the hardware server is configured to provide an additional visualization for another product for in response to the other product request.

In some embodiments, there is provided non-transitory computer-readable medium storing instructions that, when executed by a hardware processor, cause the hardware processor to perform operations comprising: extracting measurement attributes from sensor data to populate the user records in the database, the sensor data captured by sensors; collecting user preference data to populate the user records in a database, the user preference data comprising at least one of activity preference, fit preference, and feel preference, wherein the user preference data are aggregated with user physical data derived from the sensor data to generate parametric data, the database storing pattern records, user records with measurement attributes from the sensor data and user preference data, material records, and generative design models in memory; in response to a product request and customization data from an interface having a control panel of tools with parameter controls for a parametric garment pattern to receive the customization data, generate or modify the pattern and associated code files by processing the extracted measurement attributes, the parametric data, and the customization data; displaying a visualization of a product at the interface with a selectable purchase option; receiving additional customization data from the control panel of tools at the interface; and updating the visualization of the product at the interface in response to the additional customization data from the control panel of tools.

In some embodiments, there is provided computer implemented method for personalization of a product. The method involves: storing a database of pattern records, user records with measurement attributes from sensor data and user preference data, material records, and generative design models in memory; capturing sensor data for a user by sensors; extracting measurement attributes from the sensor data to populate the user records in the database; collecting user preference data to populate the user records in the database, the user preference data comprising at least one of activity preference, fit preference, and feel preference, wherein the user preference data are aggregated with user physical data derived from the sensor data to generate parametric data; in response to a product request and customization data from an interface having a control panel of tools with parameter controls for a parametric garment pattern to receive the customization data, generate or modify the pattern and associated code files by processing the extracted measurement attributes, the parametric data, and the customization data; displaying a visualization of a product at the interface with a selectable purchase option; receiving additional customization data from the control panel of tools at the interface; and updating the visualization of the product at the interface in response to the additional customization data from the control panel of tools.

In some embodiments, the extracting measurement attributes from sensor data comprises extracting breast measurement attributes from breast sensor data, and the method further comprises computing a gradient for the garment pattern using the breast measurement attributes and the user preference data.

In some embodiments, the method involves computing breast measurement attributes by detecting peaks and strides in breast sensor signals, and computing a gradient for the garment pattern using the breast measurement attributes.

In an aspect, embodiments relate to a system for providing an interface for product personalization. The system has non-transitory memory, and a hardware processor coupled to the memory programmed with executable instructions, the instructions having an interface having a control panel of tools with parameter controls for a parametric pattern to generate or modify a garment pattern, the interface displaying a visualization of the garment pattern generated or modified by the control panel of tools with parameter controls for the parametric pattern. The system has a hardware server coupled to memory programmed with further executable instructions to: extract measurement and movement attributes from sensor data or user preference data to populate user records in the memory; generate or modify the garment pattern and associated code files by processing the extracted measurement and movement attributes, and data from the interface having the control panel of tools with the parameter controls for the parametric pattern, the garment pattern and associated code files defining a perimeter pattern and a geometry of objects within the perimeter pattern, the user preference data comprising at least one of activity preference, fit preference, and feel preference, wherein user physical data derived from the sensor data provide parametric data for the parametric pattern to generate the garment pattern; trigger the display of the visualization of the garment pattern at the interface using the associated code files and output of a modeling system; a user device comprising one or more sensors for capturing the sensor data for the user, and a transmitter for transmitting the captured sensor data to the interface of the hardware processor or the hardware server over the network to personalize the product.

In another aspect, there is provided a system for providing an interface for product personalization. The system has at least one hardware processor coupled to at least one non-transitory memory programmed with executable instructions, the instructions having an interface having a control panel of tools with parameter controls for a parametric pattern to generate or modify a garment pattern, the interface displaying a visualization of the garment pattern generated or modified by the control panel of tools with parameter controls for the parametric pattern. The at least one hardware processor coupled to the at least one non-transitory memory is programmed with further executable instructions to: extract measurement and movement attributes from sensor data or user preference data to populate user records in the memory; generate or modify the garment pattern and associated code files by processing the extracted measurement and movement attributes, and data from the interface having the control panel of tools with the parameter controls for the parametric pattern, the garment pattern and associated code files defining a perimeter pattern and a geometry of objects within the perimeter pattern, the user preference data comprising at least one of activity preference, fit preference, and feel preference, wherein user physical data derived from the sensor data provide parametric data for the parametric pattern to generate the garment pattern; and trigger the display of the visualization of the garment pattern at the interface using the associated code files and output of a modeling system.

In another aspect, there is provided a system for providing an interface for product personalization. The system has non-transitory memory storing user records with measurement attributes from sensor data and user preference data. The system has a hardware processor programmed with executable instructions for an interface having a control panel of tools with parameter controls for a parametric pattern to receive customization data to generate or modify a garment pattern, the interface displaying a visualization of the garment pattern generated or modified by the control panel of tools with parameter controls for the parametric pattern. The hardware processor: extracts measurement and movement attributes from the sensor data to populate the user records; collect user preference data to populate the user records; transmits the extracted measurement and movement attributes, the user preference data, and the customization data to a hardware server that generates or modifies the garment pattern and associated code files by processing the extracted measurement and movement attributes, the user preference data, and the customization data, the garment pattern and associated code files defining a perimeter pattern and a geometry of objects within the perimeter pattern, the user preference data comprising at least one of activity preference, fit preference, and feel preference, wherein the user preference data are aggregated with user physical data derived from the sensor data to drive parametric data for the garment pattern; triggers the display of the visualization of the garment pattern at the interface using the associated code files and output of a modeling system; transmits additional customization data having the control panel of tools with the parameter controls for the parametric pattern; receives a modification of the garment pattern and the associated code files from the hardware server that generates the modification using the additional customization data from the interface having the control panel of tools with the parameter controls for the parametric pattern; triggers the update of the display of the visualization of the garment pattern at the interface in response to modification of the garment pattern and the associated code files. The hardware processor couples to a user device comprising one or more sensors for capturing the sensor data for the user, and a transmitter for transmitting the captured sensor data to the interface of the hardware processor or the hardware server over the network to personalize the product.

In a further aspect, there is provided a system for providing an interface for product personalization. The system has non-transitory memory storing user records with measurement attributes from sensor data and user preference data. The system has a hardware processor programmed with executable instructions for an interface having a control panel of tools with parameter controls for a parametric pattern to receive customization data to generate or modify a garment pattern, the interface displaying a visualization of the garment pattern generated or modified by the control panel of tools with parameter controls for the parametric pattern. The hardware processor: transmits extracted measurement and movement attributes, the user preference data, and the customization data to a hardware server that generates or modifies the garment pattern and associated code files by processing the extracted measurement and movement attributes, the user preference data, and the customization data, the garment pattern and associated code files defining a perimeter pattern and a geometry of objects within the perimeter pattern, the user preference data comprising at least one of activity preference, fit preference, and feel preference, wherein the user preference data are aggregated with user physical data derived from the sensor data to drive parametric data for the garment pattern; triggers the display of the visualization of the garment pattern at the interface using the associated code files and output of a modeling system. The hardware processor couples to a user device comprising one or more sensors for capturing the sensor data for the user, and a transmitter for transmitting the captured sensor data to the interface of the hardware processor or the hardware server over the network to personalize the product.

For various embodiments, the systems can have different features, functions or components described herein.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

Embodiments of the disclosure will now be described in conjunction with the accompanying drawings of which:

FIG. 1 shows an example system for an interface for generating or modifying garment patterns;

FIG. 2 shows another example system for an interface for generating or modifying garment patterns;

FIG. 3 shows an example system for an interface for generating or modifying garment patterns;

FIG. 4 shows a method for personalization of a product;

FIG. 5 shows a diagram of an example computing device;

FIG. 6 shows an example interface for generating or modifying garment patterns;

FIG. 7 shows an example interface for inputting user data to display a visualization of a garment.

FIG. 8 shows an example interface for generating or modifying garment patterns;

FIG. 9 shows a process for generating or modifying garment patterns;

FIG. 10 shows an interface for generating or modifying garment patterns with a control panel and a backend process for the interface;

FIG. 11 shows an example interface for generating or modifying garment patterns with a gradient optimization component, in which attractor curves are generated;

FIG. 12 shows an example interface for generating or modifying garment patterns with a control panel and a visualization of a pattern with attractor curves;

FIG. 13 shows an example interface for generating or modifying garment patterns with a gradient optimization component in which the gradient is generated;

FIG. 14 shows an interface for generating or modifying garment patterns with a control panel and a visualization with a gradient optimization component;

FIG. 15 shows an example interface for generating or modifying garment patterns with a visualization of pattern parameters with an optimization component;

FIG. 16 shows an example interface for generating or modifying garment patterns with a visualization of pattern parameters

FIG. 17 shows an example interface for generating or modifying garment patterns with a preview visualization for the customization process for generating or modifying garment patterns, before a pattern is exported;

FIG. 18 shows an example interface for generating or modifying garment patterns with a preview visualization;

FIG. 19 shows example generated or exported garment pattern files;

FIG. 20 shows an example method of generating a personalized or customized garment;

FIG. 20A shows an example method of generating a personalized or customized garment;

FIG. 20B shows another example method of generating a personalized or customized garment;

FIG. 21 shows an example interface for customizing garments;

FIG. 22 shows an example interface for customizing garments;

FIG. 23 shows an example interface for customizing garments;

FIG. 24 shows an example interface for customizing garments;

FIG. 25 shows an example interface for customizing garments alongside a spreadsheet outlining user data used to generate the garment pattern;

FIG. 26 shows an example interface for customizing garments alongside a spreadsheet outlining user data used to generate the garment pattern;

FIG. 27 shows exemplary garment patterns for pants;

FIG. 28 shows an example visualization of a garment;

FIG. 29 shows an example visualization of a garment with objects to define a geometry for the garment pattern;

FIG. 30 shows an example visualization of a garment with a control panel of parameter controls including falloff controls;

FIG. 31 shows an example visualization of a garment with a control panel of parameter controls including falloff controls;

FIG. 32 shows an example visualization of a garment with a control panel of parameter controls including pattern parameter controls;

FIG. 33 shows an example visualization of a garment with a control panel of parameter controls including pattern parameter controls;

FIG. 34 shows an example visualization of a garment with a control panel of parameter controls including pattern parameter controls;

FIG. 35 shows an example visualization of a garment with different pattern pieces;

FIG. 36 shows an example visualization of a garment pattern piece for pants;

FIG. 37 shows an example visualization of a garment pattern piece for pants with attractor lines; and

FIG. 38 shows an example visualization of garment pattern pieces for pants.

FIG. 39A and FIG. 39B show example visualizations of a garment pattern demonstrating the effect of moving an attractor curve on the resulting gradient.

FIG. 40A and FIG. 40B show example visualizations of a garment pattern with a control panel of parameter controls including falloff controls demonstrating the effect of altering the falloff on the resulting gradient.

FIG. 41A and FIG. 41B show example visualizations of a garment pattern with a control panel of parameter controls including pattern parameter controls demonstrating the effect of altering the cell size on the resulting pattern.

FIG. 42A and FIG. 42B show example visualizations of a garment pattern with a control panel of parameter controls including pattern parameter controls demonstrating the effect of altering grid type on the resulting pattern.

### DETAILED DESCRIPTION

Embodiments relate to methods and systems with non-transitory memory storing a database of pattern records, user records for user data across multiple channels, such as image data relating to the user, data defining physical characteristics of the user, and data relating to user preferences, material records, and generative design models. The methods and systems involve a hardware processor having an interface to provide a control panel of tools to generate or modify a garment pattern. A hardware processor can generate or modify a garment pattern and associated code files by processing extracted measurement attributes, customization data, and user preference data from a control panel of tools at the interface. The interface can display visual elements for the garment pattern. The display of the visual elements can be controlled by the hardware processor by interacting with a modelling system, for example. The user preference data includes different types of user data, such as activity preference, fit preference, feel preference, and so on. These preferences are combined with the user's physical sensor data to drive the parametric data. User data includes both user preferences and users physical data (e.g. captured by sensors).

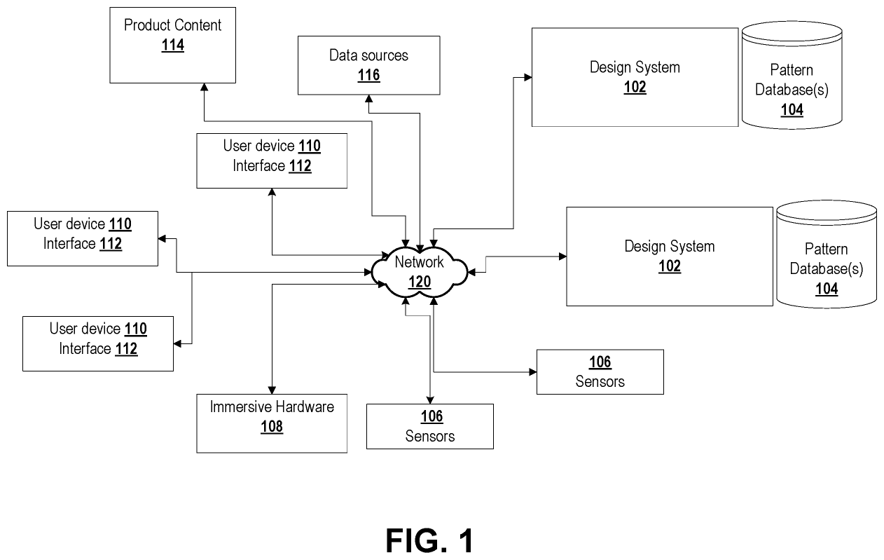

FIG. 1 shows an embodiment of a design system 102 for generating personalized or customized products. An example product is a garment, such as a shirt, pants, jacket, bra, underwear, and so on. The garments or products are generated using patterns. The system 102 has non-transitory memory storing a database 104 of pattern records, user records, including measurement attributes from sensor data and user preference data, material records. A user device 110 has a hardware processor programmed with executable instructions for interacting or communicating with an interface 112. The interface 112 has a control panel of tools with parameter controls for a parametric pattern to receive customization data to generate or modify a garment pattern. The interface 112 displays a visualization of the garment pattern generated or modified by input at the parameter controls for the parametric pattern. The system 102 has a hardware server coupled to the memory to access the database 104. The interface 112 can also be integrated as of the server in other embodiments. The hardware server is programmed with executable instructions to extract measurement and movement attributes from the sensor data and collect user preference data to populate the user records in the database 104. The hardware server can generate or modify the garment pattern and associated code files by processing the extracted measurement and movement attributes, the user preference data, and the customization data from the parameter controls for the parametric pattern. The hardware server can generate or modify the garment pattern and associated code files using the pattern records, which can include base patterns for different types of garments. The garment pattern and associated code files can define a perimeter pattern and a geometry of objects within the perimeter pattern. The system 102 can trigger the display of the visualization of the garment pattern at the interface 112 using the associated code files and output of a modeling system.

The system 102 can receive additional customization data from the interface 112 with the parameter controls for the parametric pattern. In response, the system 10 can modify the garment pattern and the associated code files using the additional customization data from the interface and trigger the update of the display of the visualization of the garment pattern at the interface 102. The system has sensors 106 and immersive hardware 108 for capturing the sensor data for the user and collect the preference data for the user, and a transmitter for transmitting the captured sensor and preference data to the interface 112 of the hardware processor or the hardware server of the system 102 over the network to personalize the product. In some embodiments, the interface can transmit another product request, and the hardware server is configured to provide an additional visualization for another product for in response to the other product request. The user preference data is aggregated with physical sensor data to drive the parametric data for the garment pattern. User data includes both user preferences and users physical data (e.g. captured by sensors).

The interface 112 has a control panel of tools with different types of parameter controls for the parametric pattern. Example parameter controls include gradient parameter controls for modifying gradient parameters for the parametric pattern, attractor curve parameter controls for modifying attractor curve parameters for the parametric pattern, pattern parameter controls for modifying pattern parameters for the parametric pattern, and preview parameter controls for modifying preview parameters for the parametric pattern. In some embodiments, the parameter controls for the parametric pattern involve shape, size, falloff rate and interaction parameter controls.

In some embodiments, the system 102 generates or modifies the garment pattern and the associated code files using the pattern records by selecting a base pattern for the garment and a base gradient. The system 102 optimizes the base pattern for the garment and the base gradient for a desired outcome or feel state. In some embodiments, the system 102 generates or modifies the garment pattern and the associated code files using the pattern records by adjusting the base pattern for the garment and the base gradient using the extracted measurement and movement attributes and the user preferences. In some embodiments, the system 102 generates or selects a base pattern using generative design models processing the user data, the base pattern for generating or modifying the garment. In some embodiments, the system 102 updates the generative design models based on feedback data on the product.

The system 102 can define quantifiable desired feel states. The server 10 can define quantifiable targets using different forms of statistical analyses (i.e. a principle component analysis) to identify the variables with most effect on feel state. These variables are then put through a protocol whereby the system 102 adjust the pattern parameters and the ‘quantifiable metric’ to see which quantity drives the sensation. For example, the data may indicate that for the sensation of ‘thermal comfort’ the skin wetness variable is the highest rated variable. The system 102 can then test different percentages of skin wetness to find between 30-50% skin wetness is the quantified target to feel thermally comfortable. Bra comfort variable is another example. The system 102 can define peak acceleration of the breast as an important variable and can define specific m/s/s acceleration targets for different breast volumes. The sensor data can be used for breast volume data. In the mindfulness space, specific HRV data can be associated with calm or stress. For product specific variables and the bra example, the system 102 can define bra structure as underwire X+material modulus Y meets the acceleration target and therefore provides values for the bra comfort sensation. Further, the glute compression A and thigh compression B can provide confident sensation in pants.

The system 102 generates or modifies the garment pattern and the associated code files by optimizing parameters configurations. The system 102 generates or modifies the garment pattern using the pattern records by selecting a base pattern for the garment and a base gradient to be optimized. The system 102 optimizes the base pattern for the garment and the base gradient for a desired outcome by optimizing shape, size, falloff rate and interaction parameters based on input from the shape, size, falloff rate, and interaction parameter controls.

The sensors 106 and immersive hardware 108 capture data defining physical or behavioural characteristics of the user by video data or audio data. In some embodiments, the system 102 generates measurement metrics using at least one of 3D scanning, machine learning prediction, user measuring, and garment measuring. In some embodiments, the system 102 generates movement metrics based inertial measurement unit (IMU) data, computer vision, pressure data, and radio-frequency data. In some embodiments, the system 102 extracts the user attributes from user data comprising at least one of purchase history, activity intent, interaction history, and review data for the user for selecting garments or products that can then be personalized.

The system 102 can generate or modify patterns for different types of products and garments,

In some embodiments, the garment pattern is for a bra. The sensors 106 and immersive hardware 108 can capture breast movement data as user data. The system 102 can extract measurement and movement attributes such as side to side acceleration, up and down acceleration, displacement and angle of peak acceleration. The system 102 can customize the bra for different desired outcomes relating to support, for example. The bra can be a high support bra or a low support bra. In some embodiments, the garment pattern is for tights or pants. The sensors 106 and immersive hardware 108 can capture leg region movement data. The system 102 can extract measurement and movement attributes such as side to side acceleration, up and down acceleration, displacement and angle of peak acceleration for objects in the leg region. The system 102 can customize the pants for different desired outcomes relating to support. Other types of garments or products can be customized or personalized by the system 102. In some embodiments, the interface 112 receives a modification request for the product and system 102 updates the garment pattern and the associated code files based on the modification request.

The sensors 106 and immersive hardware 108 can capture movement data for different portions of a user. The system 102 can extract measurement and movement attributes such as side to side acceleration, up and down acceleration, displacement and angle of peak acceleration for different portions of the user.

In some embodiments, the system 102 generates perceptual preference metrics based on at least one of garment sensation, preferred handfeel, thermal preference, and movement sensation. The system 102 can use the perceptual preference metrics for generating the pattern and material for the garment. In some embodiments, the hardware processor computes a preferred sensory state as part of extracted user attributes. The system 102 can use the preferred sensory state for generating the pattern and material for the garment.

In some embodiments, the database 104 comprises simulated garment records, and the system 102 generates simulated product options as part of the product and associated code files, and wherein the interface displays a visualization of the simulated product options. In some embodiments, the simulated product options comprise at least one of soft body physics simulation, hard body physics simulation, static 3D viewer and AR/VR experience content.

The present disclosure seeks to provide improved methods and systems for an interface for personalization of products for users by capturing user data and classifying user attributes. While various embodiments of the disclosure are described below, the disclosure is not limited to these embodiments, and variations of these embodiments may well fall within the scope of the disclosure which is to be limited only by the appended claims. Of explanation the term product can be used herein to refer to products and/or services.

In some embodiments, the system 102 selects a base pattern or the garment (to be customized) using the emotional signature metrics from the user data. The system 102 generates emotional signature metrics based on at least one of personality data, mood state data, emotional fitness data, personal values data, goals data, and physiological data, wherein the emotional signature metrics comprise social signature metrics, connectedness metrics, or resonance signature metrics. In some embodiments, the hardware server is configured to determine an emotional signature of one or more additional users; determine users with similar emotional signatures; predict connectedness between users with similar emotional signatures; and generate the product using data corresponding to the users with similar emotional signatures.

According to some embodiments of the disclosure, there are described methods and systems for personalization of products or recommendations of products that involves selection of the products (or aspects thereof) by determining the emotional signature of a user. The emotional signature may be a composite metric derived from the combination of a measure of a personality type of the user (e.g. a measure of, for example, the user's openness/intellect, conscientiousness, extraversion, agreeableness, and neuroticism/emotional stability) and levels or states of cognitive-affective processes or competencies (e.g. attention, emotion regulation, awareness, compassion, etc.). The system 102 can further optimize values of parameters using unique quantified targets based on an individual's physical and emotional uniqueness and their optimal feel state. The system 102 can update the values of parameters and adjust the weighting for different target feel states and emotional signatures. The order or the quantity of the parameters can change individually. For example, variable Comfortable for Person 1 may be defined as needing a peak acceleration from 3-5 m/s/s and person 2 may need a peak acceleration from 7-9 m/s/s. Each individual may also have unique needs for under band compression or other components of the bra. Instead of generically defining bra comfort to be peak acceleration of 5 m/s/s and a under band compression of 13 mmHg for all users, the system 102 can generate a personalized garment (bra) that can customise the variable values or numbers for individuals. As another example, thermal comfort can be a unique variable for each user. Person 1 can have a specific need of 30% skin wetness and this can be combined with a specific material surface roughness or conduction metric to customize the product for the user. In a mindfulness space, the server 10 can normalise the range of HRV to match the ability of the user to manage stress. Person A with HRV x and person B with HRV y may both feel the same level of calm due to their innate ability to manage stress, by way of example. The system 102 can determine the known bra size, combined with the user's fit preference and activity for input into a prediction model to accurately predict breast acceleration.

In order for the interface 112 to generate personalized products, devices described herein may use one or more sensors 106 to capture user data relating to the user. The sensors may include, for example, audio sensors (such as a microphone), optical sensors (such as a camera), tactile sensors (such as a user interface), biometric sensors (such as a heart monitor, blood pressure monitor, skin wetness monitor, electroencephalogram (EEG) electrode, etc.), location/position sensors (such as GPS) and motion detection or motion capturing sensors (such as accelerometers) for obtaining the user data. The user data may then be processed (using, for example, any of various face and body modelling or analysis techniques) and compared to stored, reference user data to determine the user's attributes, which can include movement and measurement metrics, and also emotional signature metrics that can be used to determine personality type and states of cognitive-affective competencies. For example, the processed user data may be used to determine one or more of the user's physical and behavioural characteristics such as height, weight, waist size or current mood state. The methods and systems can generate personalization of garments using the user's physical or behavioural characteristics, along with movement metrics that can impact construction of the product and materials for the product.

In some embodiments, based on the user's physical or behavioural characteristics, a personalized garment pattern and associated code files is generated or modified by using generative design models to process the measurements of the user's physical characteristics along with customization data supplied by the user through a control panel at the interface 112. The generative design models can use the pattern records. The visualization of the generated garment is displayed at the user interface, allowing the user to review the garment and make modifications to generate the personalized product. The user may provide additional customization data, which the system uses to modify the generated garment and update the visualization of the garment at the user interface.

FIG. 1 shows an embodiment of a product personalization system that may implement the methods described herein. Product personalization system comprises design systems 102 have one or more pattern databases 104 stored on non-transitory memory. User devices 110 have interfaces 112. Design systems 102, sensors 106, immersive hardware 108, and user devices 110 have hardware processors that are communicatively coupled to one another via network 120 (such as the Internet). Thus, data may be transferred between sensors 106 and design systems 102 by transmitting the data using network 120, for example. The design systems 102 include non-transitory computer readable storage medium storing instructions to configure one or more hardware processors to provide an interface for collecting sensor and preference data, and exchanging data and commands with other components of the system.

While two sensors 106 are shown in FIG. 1, design system 102 can be used by any suitable number of sensors 106, and even a single sensor 106. The sensors 106 may include a camera, a microphone, location/position sensors, motion detection sensors or motion capturing sensors, for example. In some embodiments, multiple sensors may be integrated into a single device. In some embodiments, one or more sensors may be integrated with an immersive hardware device 108, such as a smart mirror.

A number of users of design system 100 may use interfaces 112 of user devices 110 to exchange data and commands with design systems 102 in manners described in further detail below. While three user devices 110 are shown in FIG. 1, product personalization system 100 is adaptable to be used by any suitable number of users, and even a single user. Furthermore, while product personalization system 100 shows two design systems 102 and two databases 104, product personalization system 100 extends to any suitable number of design systems 102 and pattern databases 104 (such as a single design system communicatively coupled to a single pattern database).

In some embodiments, the functionality of pattern databases 104 may be incorporated with that of servers of the design systems 102 with non-transitory storage devices or memory. In other words, the servers of the design systems 102 may store the user data located on pattern databases 104 within internal memory and may additionally perform any of the processing of data described herein. However, in the embodiment of FIG. 1, servers of the design systems 102 are configured to remotely access the contents of pattern databases 104 when required.

Example systems and methods for personalization or recommendation of products is described in PCT Application No. PCT/CA2021/050282 by the applicant, the entire contents of which is hereby incorporated by reference. The personalized or recommended product may be a garment, for example, defined by garment patterns.

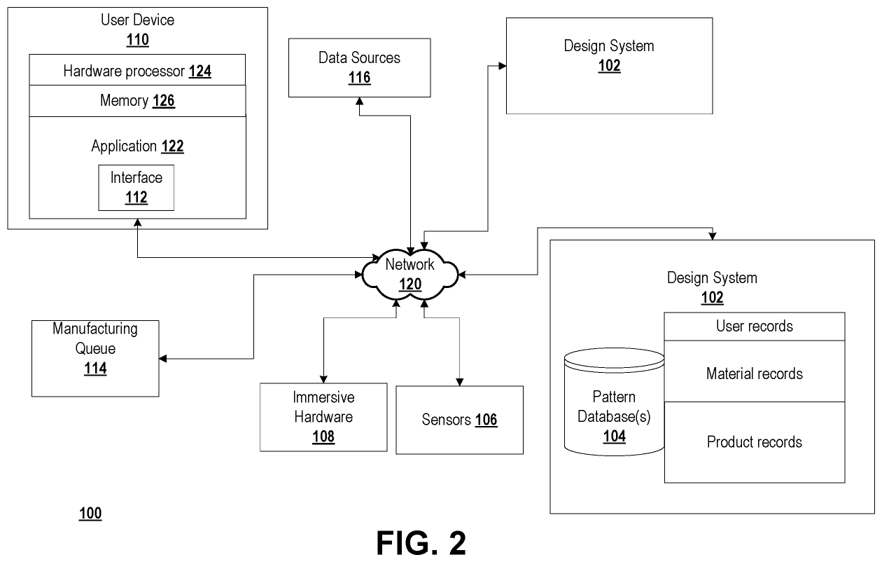

Turning to FIG. 2, there is shown an embodiment of a product personalization system 100 in more detail. User device 110 includes a hardware processor 124 with a computer-readable medium 126, such as suitable computer memory, storing computer program code. The hardware processor 124 is communicative with each of sensors 106 and is configured to control the operation of sensors 106 in response to instructions read by processor 124 from non-transitory memory 126 and receive data from sensors 106 According to some embodiments, user device 110 is a mobile device such a smartphone, although in other embodiments user device 110 may be any other suitable device that may be operated and interfaced with by a user. For example, user device 110 may comprise a laptop, a personal computer, a tablet device, a smart mirror, a smart display, a smart screen, a smart wearable, or an exercise device.

Design systems 102 have one or more pattern databases 104 stored on non-transitory memory. Pattern databases 102 contain user records storing user data, material records storing data about garment materials, and product records storing garment designs for personalization and modification. The user data stored in the user records includes user data collected by sensors 106. The patterns can correspond to different types of garments or apparel, such as bras, tights, pants, shirts, and so on.

Sensors 106 are configured to obtain user data relating to a user. For example, a microphone may detect speech or utterances from a user whereupon processor may convert the detected speech into voice data. The user may input text or other data into user device 110 via interface 112, whereupon processor 124 may convert the user input into text data. Furthermore, a camera may capture images of the user, for example when the user is interfacing with user device 110. The camera may convert the images into image data relating to the user. The user interface 112 can send collected data from the different components of the user device 110 for transmission to the design system 102 and storage in the pattern database 104 as part of data records that are stored with an identifier for the user device 110 and/or the user.

One or more sensors 106 may be integrated with an immersive hardware device 108. The immersive hardware device 108 captures audio data, image data and data defining physical or behavioural characteristics of the user, to be stored in the pattern databases 104 as user data. Immersive Hardware 108 may be connected to the other components of system 100 through Wi-Fi, Bluetooth, or another communication protocol.

In addition to data from sensors 106, the system 100 may also receive data from additional data sources 116. Data sources 116 may include biometric data, ping data, or data collected from social media. This data may be used to supplement the user data collected by sensors 106 and stored in the user records in pattern databases 104.

User device 110 may be a personal computer, a smartphone, a tablet, or any other computing device. User device 110 contains a processor 124, which has non-transient memory 126 programmed with executable instructions for executing or controlling application 122. Application 122 provides an interface 112 through which the user can interact with system 100. Interface 112 has a control panel of tools. The control panel of tools has generative design models and the user can also provide customization data using the control panel, such as a selected garment type, preferred garment colour and pattern, for example.

Using interface 112, a user can submit a product request. In response to a product request, processor 124 transmits the product request to the design system 102, which generates or modifies a garment pattern and associated code files stored in the pattern databases 104 based on the user data stored in pattern databases 104 and customization data provided by the user. The product request can indicate a selected garment type, and other garment attributes.

Once a product has been designed, a visualization of the product is displayed at interface 112. The interface 112 then provides the user with the option to purchase the product or to supply additional customization data. If the user provides additional customization data, the visualization of the garment is updated to reflect this additional data.

In some embodiments, the system 102 transmits manufacturing instructions for the product in response to receiving purchase instructions at the interface. In some embodiments, the system 102 generates the product and associated code files by generating bill of material files. In some embodiments, the system 102 generates the product and associated code files by assembling content files. If the user chooses to purchase the product, the interface 112 or system 102 transmits purchase instructions for the product and transmits manufacturing instructions for the product to manufacturing queue 114. The product may then be manufactured according to the specified design encoded in product design files and delivered to the user.

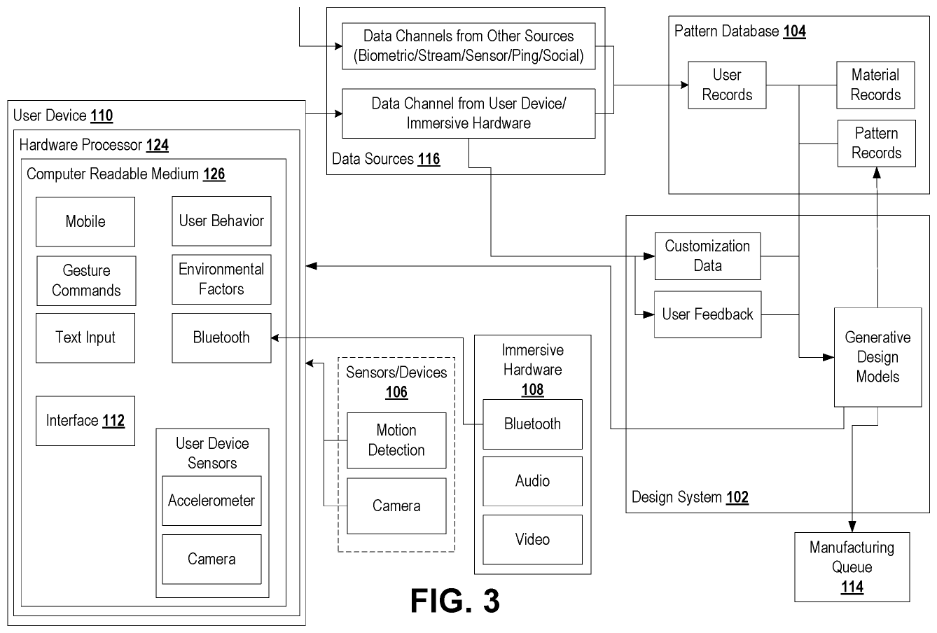

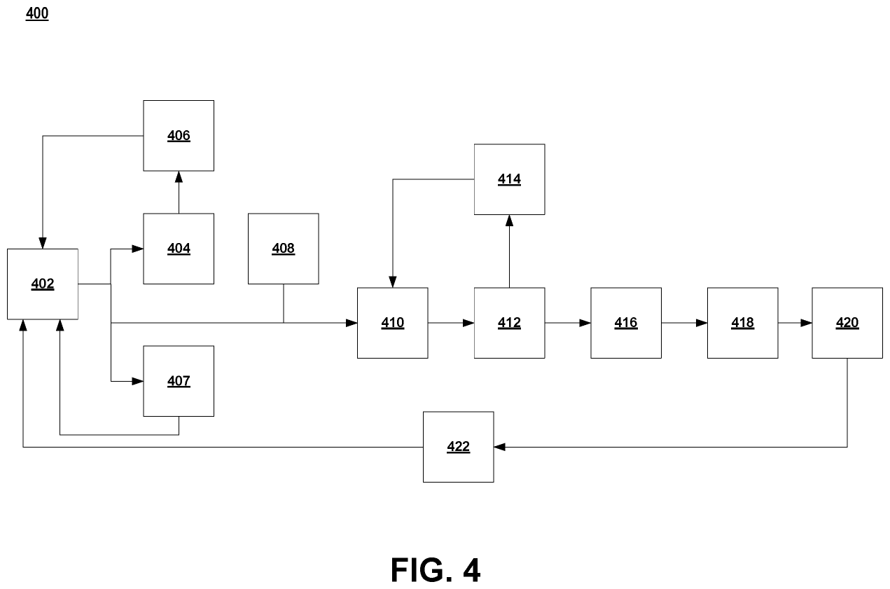

Turning to FIG. 3 there is shown another embodiment of design system 100. The system has sensors 106, immersive hardware, 108, user device 110, data sources 116, pattern database 104, design system 102, and manufacturing queue 114. The Generative Design Models 102 can be used to generate parametric patterns or garment patterns for the interface. The user data, sensor data and pattern database can be used for parametric data for the patterns.

Sensors 106 collect data about the user. The sensors may include, for example, motion detection sensors, cameras, or microphones. Sensor 106 may be integrated as part of immersive hardware 108 or user device 110.

Immersive hardware 108 has sensors which collect data about the user. For example, immersive hardware 108 may have a microphone to collect audio data and a camera sensors to collect video data. The immersive hardware 108 may be communicatively coupled to user device 110, for example, via Bluetooth.

User device 110 has a hardware processor 124 with a non-transient computer readable medium 126 such as suitable computer memory. User device 110 may, for example, be a smartphone, desktop computer, laptop computer, or tablet computer. User device 110 may have sensors for collecting user data, such as a camera or accelerometer, for example. User device 110 also receives user data from other sensors 106 and 108. User device 110 has an interface 112 through which the user may interact with the system 102. The user may interact with the system 102 through text input, gesture commands, or voice commands, for example.

User device 110 may transmit user data through data sources 116 to user records in database 104. In addition to data from user device 110, data sources 116 may include data from other sources, such as biometric data, stream data, sensor data, preference data, ping data, or social media data.

Pattern database 104 stores user records, material records and pattern records. In some embodiments, pattern database 104 may also store one or more of grading rules, grading records, bill of materials records, construction records, or layup records. In some embodiments, pattern database 104 may be integrated with design system 102.

In response to a user request to personalize a product, user records, material records, pattern records, grading rules, grading records, bill of materials records, construction records, and layup records may be transmitted to design system 102. Generative design models in design system 102 are used to generate personalized products based on user data, such as the physical characteristics of the user and movement data, for example. Design system 102 provides a visualization of the product to user device 110 for review by the user. The user may provide, through user device 110, additional customization data which is used by the generative design models to update the generated garment. The user may also provide, through user device 110, feedback on the generated product, which may also be used by the generative design models to update the generated garment.

Design system 102 models may transmit data about the personalized product, along with customization data and user feedback, to pattern database 104 in order to update the pattern records and improve personalization for future users. For example, if a majority of users request a specific customization made as part of a product personalization, the pattern records may be updated to include that customization by default.

Once the user is satisfied with the generated product and has no additional customization data to submit, the product design is transmitted to manufacturing queue 114 to be manufactured and sent to the client.

Turning to FIG. 4, there is shown a method for personalization of a product.

At 402, the process involves design system 102 storing data in an attributable database in memory 402, such as pattern database 104. The data can be user data, material data, and product data and design system 102 can populate the attributable pattern database 104. The database 104 contains pattern records, user records with measurement attributes from sensor data and user preference data, material records, generative design models, grading rules, grading records, bill of materials records, construction records, and layup records. This can pre-initialize the pattern database 104 with product related data.

At 404, the design system 102 collects sensor data for a user. This user data may include visual data, audio data, motion detection data, biometric data, activity preference data, fit preference data, feel preference data or any other data for measuring the physical or behavioural characteristics of the user.

Having collected sensor data and user preference data, at 406, design system 102 extracts measurement attributes from the sensor data and populates user records in the database 104. The database 104 continues to store user records (at 402) and these records may be updated as new sensor data is collected at 404 and measurement attributes are extracted 406.

At 407, the design system 102 collects user preference data. This user preference data may include activity preference data, fit preference data, feel preference data, or any other data for measuring user preferences and populates user records in the database 104. The design system 102 can also collect additional product related data and populate product records. The database 104 continues to store user records and other records (at 402) and these records may be updated as new user preference data and/or product related data is collected at 407.

A user may submit a product request at 408 to the design system 102 from an interface 112. The interface 112 may display different types of products for selection. The interface 112 can receive a selected product to trigger the transmission of the product request to the design system 102.

The design system 102 updates the interface 112 with a control panel for a 3D modeling system. The control panel at the interface 112 can receive parameters and configurations to personalize the selected product to generate a pattern and associated code files.

In response to the product request received at 408, the design system 102 generates a pattern and its associated code files at 410 based on the parameters configured using the control panel of the interface 112, or modifies a pattern and its associated code files from the database 104. The design system 102 processes the extracted measurement attributes and user preference data from the database 104 using the generative design models stored in the database along with customization parameters supplied by the user at a control panel of tools at the interface 112.

At 412, a visualization of a garment is then rendered by the 3D modeling system using the output code files generated by the control panel at the interface 112. The visualization of the garment is displayed at the interface 112. The visualization of a garment can be displayed with a selectable purchase option.

In response to the visualization, the user may submit additional customization data at 414 from the control panel of tools at the interface 112. For example, if the user wishes to change the material to be used in the product, this may be provided as additional customization data.

Upon receiving additional customization data, the product code files will be modified using the previously generated product and the additional customization data 410, and the visualization of the garment at interface 112 will be updated at 412. The user will again be provided a selectable purchase option, and the control panel can be used to continue to personalize or update the product.

If the user wishes to purchase the product and selects the selectable purchase option, purchase instructions will be received at 416. The interface 112 can transmit the purchase instructions to the design system 102. Purchase instructions may include payment method, shipping address, and any other data required to complete the purchase.

Upon receiving purchase instructions 416, manufacturing instructions can be transmitted 418 to a manufacturing queue to trigger production and delivery of the personalized product.

After receiving the product the user may provide, and the system may receive feedback on the product 420. For example, in the case of athletic wear the user may provide feedback on the level of support the garment provides, the quality of the garment, the texture of the garment, or other attributes of the garment.

Based on the received feedback, the design system 102 can update the generative design models used to create the product at 422. For example, if the user is satisfied with certain aspects of the garment, the generative design model may be updated by the design system 102 to prefer generating products with those aspects. Conversely, if the user is dissatisfied with a particular attribute of the product, the generative design model may be updated to become less likely to generate a product with that attribute. The modified generative design model is then stored in the database 402 for future product generation.

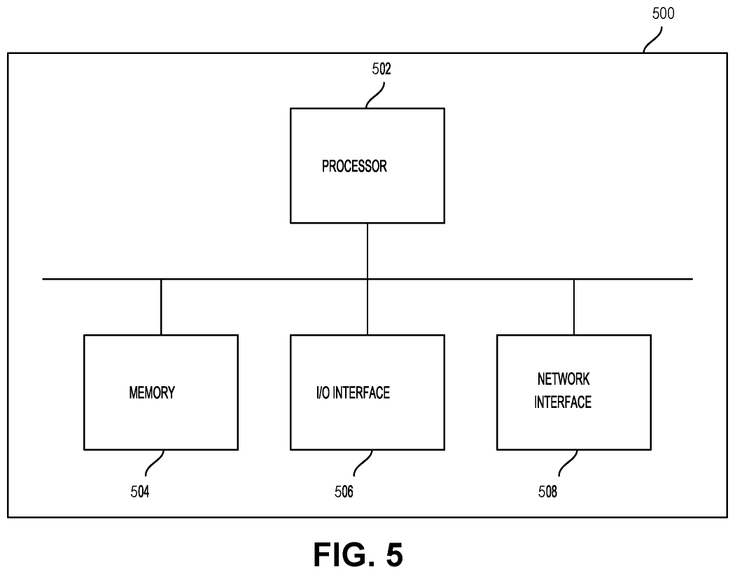

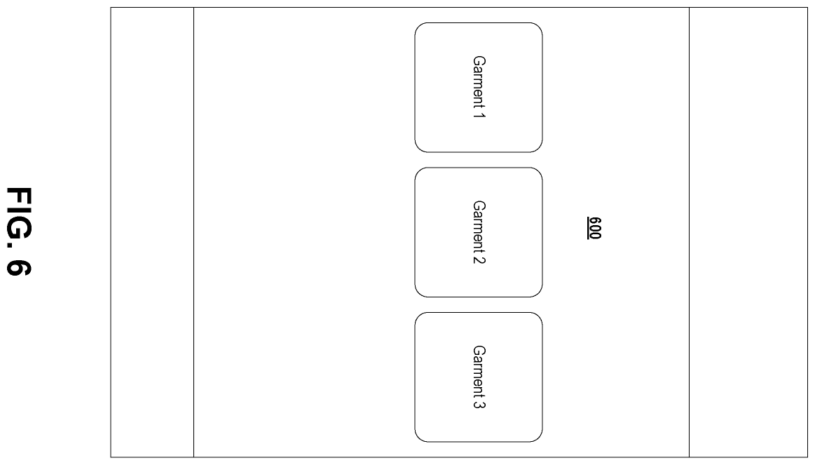

FIG. 5 shows an example schematic diagram of a computing device 500 that can implement aspects of embodiments, such as aspects or components of user devices 110, design systems 102, or databases 104. As depicted, the device 500 includes at least one hardware processor 502, non-transitory memory 504, and at least one I/O interface 506, and at least one network interface 508 for exchanging data. The I/O interface 506, and at least one network interface 508 may include transmitters, receivers, and other hardware for data communication. The I/O interface 506 can capture user data for transmission to another device via network interface 508, for example.

The device 500 can be used to implement aspects or components of user devices 110, design systems 102 for providing an interface 112 for product personalization. The device 500 has non-transitory memory 504, and a hardware processor 502 coupled to the memory 504 programmed with executable instructions. The instructions are for an interface 112 having a control panel of tools with parameter controls for a parametric pattern to generate or modify a garment pattern. The interface 112 displays a visualization of the garment pattern generated or modified by the control panel of tools with parameter controls for the parametric pattern. The device 500 can couple to a hardware server (e.g. design system 102) programmed with further executable instructions to: extract measurement and movement attributes from sensor data or user preference data to populate user records in the memory The design system 102 can generate or modify the garment pattern and associated code files by processing the extracted measurement and movement attributes, and data from the interface 112 having the control panel of tools with the parameter controls for the parametric pattern. The garment pattern and associated code files define a perimeter pattern and a geometry of objects within the perimeter pattern, the user preference data comprising at least one of activity preference, fit preference, and feel preference. User physical data derived from the sensor data provide parametric data for the parametric pattern to generate the garment pattern. The device 500 can trigger the display of the visualization of the garment pattern at the interface 112 using the associated code files and output of a modeling system. The device 500 can be used to implement aspects of the user device 110 and can have one or more sensors for capturing the sensor data for the user, and a transmitter for transmitting the captured sensor data to the interface 112 or a hardware server to personalize the product.

In a further aspect, the hardware processor 502 is programmed with executable instructions for an interface 112 having a control panel of tools with parameter controls for a parametric pattern to receive customization data to generate or modify a garment pattern. The interface 112 displays a visualization of the garment pattern generated or modified by the control panel of tools with parameter controls for the parametric pattern. The hardware processor 502 transmits extracted measurement and movement attributes, the user preference data, and the customization data to a hardware server that generates or modifies the garment pattern and associated code files by processing the extracted measurement and movement attributes, the user preference data, and the customization data, the garment pattern and associated code files defining a perimeter pattern and a geometry of objects within the perimeter pattern. The user preference data can be activity preference, fit preference, and feel preference. The hardware processor 502 triggers the display of the visualization of the garment pattern at the interface 112 using the associated code files and output of a modeling system. The hardware processor 504 can couple to one or more sensors for capturing the sensor data to derive measurements for the user, and a transmitter for transmitting the captured sensor data to the interface 112 to personalize the product.

FIG. 6 illustrates an example of a user interface for generating or modifying garment patterns. The user interface 00 displays multiple selectable garments 600 that may be selected by the user for personalization, and eventually the personalized product may be purchased by the user and manufactured in response to control command from interface 112. By selecting a garment from the interface 112, the user device transmits a product request to the design system, initializing the generation of a personalized product.

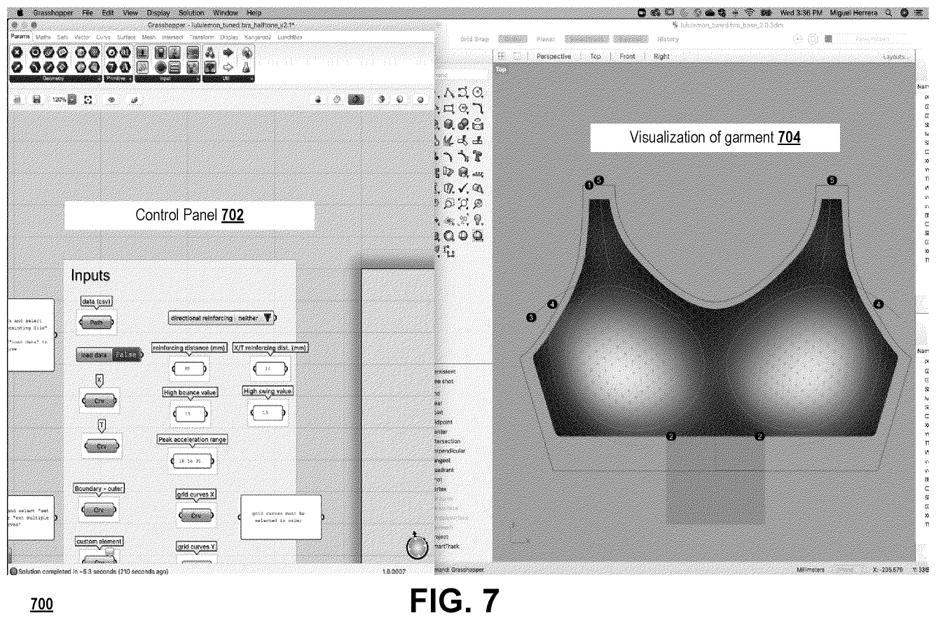

FIG. 7 shows an example interface 700 for providing user data and displaying a visualization of a garment. In the example interface, the garment being personalized is a bra. The interface 700 has a control panel 702 of tools. The interface 700 also has a visualization of a garment 704 corresponding to the user data and input from the control panel 702. The interface 700 also has a visualization of a garment 704 corresponding to configurations and parameters for garment pattern files. The captured data is used to generate the personalized product and associated pattern files. The control panel 702 displays input data and parameters, along with associated values for different parameters. Parameters may include, for example, gradient intensity, gradient falloff, grid type, cell shape, cell size, minimum and maximum cell scale, area threshold, cell border thickness, and mesh thickness. Examples of parametric data can be derived from any of the user data such as physical, emotional or preferential data. The pattern updates in response to receiving new values for different parameters.

The visualization of the garment 704 displays a visual rendering of the base pattern for the garment and material properties. The material for the garment can be defined by multiple geometric objects connected to define a geometry or mesh structure for the material of the garment. The visualization of the garment 704 displays attractor curves (shown as curved lines) to visually indicate lines that create a gradient which in turn attracts geometric elements of the garment material. Attractor curves include multiple attractor points that act like virtual magnets that can either attract or repel geometric objects to define characteristics of the garment. For example, the shapes may define the elasticity of the garment material or may define holes cut into the fabric for venting. Further examples include layout holes, apply colour, apply other functional surface application such as water repellency, or anti microbial. The visualization of the garment 704 displays gradients to represent the characteristics of the garment material at a given point (shown as a greyscale gradient in FIG. 7) and a mesh of shapes that make up garment's structure. For example, the material may be made of a mesh of objects that can provide support, and the parameters for the object properties can adjust level of support provided by the material, with a higher shape density may providing more support and less stretch. This is an example and different geometric shapes can be used to engineer any other desired effect. The attractor curves drive the creation of the gradient, with the gradient reaching a local maximum (indicating low elastic modulus or stretch) at the attractor curves and decreasing value (increasing elastic modulus or stretch) as the distance from the attractor curves increases. In turn, the gradient drives the creation of the mesh of objects, with a higher gradient value leading to an increased shape density and the rate of change in the gradient determining the shape falloff. Flexibility can be considered based on how supple the material is, for example. Shape density may vary due to variation is the size of the shapes, variation of the spacing between shapes, or both. The shapes can both increase and decrease in size as well as the number or quantity of shapes. The objects can have different shapes. The control panel 702 can trigger the input of the user data for use in designing the garment. The user data can be movement data, measurement data, emotional signature data, or user preference data. The user data can populate different parameter values for designing or personalizing the garment. The control panel 702 can receive different parameter values for designing or personalizing the garment. For example, the control panel 702 may display an angle value of maximum acceleration or the maximum observed lateral acceleration of the user's breasts computed based on the user data. For example, in the example of an interface 700 for personalizing a bra, parameters may include the maximum allowable lateral displacement of the wearer's breasts (swing) during normal physical activity, the maximum vertical displacement of the wearer's breasts (bounce) during normal physical activity, and whether the sports bra will feature directional reinforcement and corresponding values for the directional reinforcement. The control panel 702 of tools displays various parameters and fields to receive different parameter values to customize the garment and associated pattern files. For example, the user data may specify whether or not the garment should provide directional reinforcement and corresponding values or threshold ranges for the directional reinforcement.

The visualization of the garment 704 displays a visual rendering of the base pattern for the garment, attractor curves, (shown as curved lines) gradients, and a mesh of shapes that make up garment's structure and provide support (e.g. a higher shape density provides more support and less stretch). The parameter values can trigger updates to the display of the attractor curves and gradient visualizations.

The attractor curves drive the creation of the gradient visualizations, with the gradient reaching a local maximum (indicating low elastic modulus) at the attractor curves and decreasing value (increasing elastic modulus) the as distance from the attractor curves increases. In turn, the gradient drives the creation of the visualization of the mesh of shapes, with a higher gradient value leading to an increased shape density and the rate of change in the gradient determining the shape falloff.

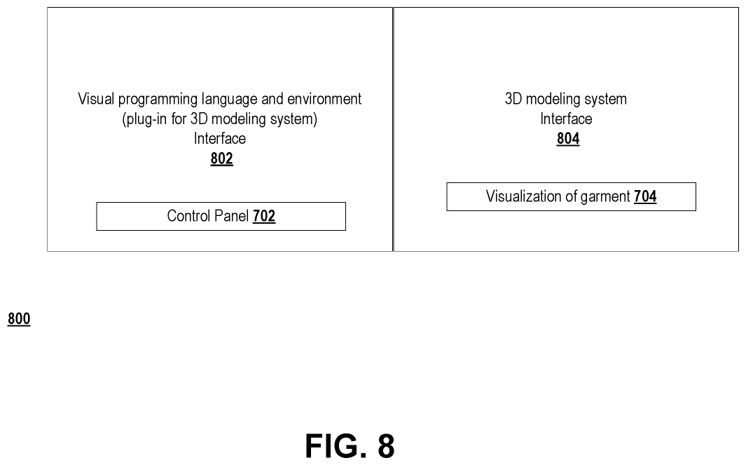

FIG. 8 shows another view of an example interface 800 for generating or modifying garment patterns. The interface 800 can be part of a visual programming language and environment and can include an embedded interface 802 for a plug-in for a 3D modeling system. The plug-in can be a software application that adds new functions to a host 3D modeling program without altering the host program itself, for example. The interface 800 can be part of a 3D modeling system (or 2D modeling system) and can have an embedded interface 804 for the 3D modeling system. The embedded interface 802 for the plug-in can use the functionality of the 3D modeling system and allows a process to be configured which parametrizes the 3D modeling system for a specific function to generate the garment patterns. The plug-in for the 3D modeling system can provide a visual interface for building processes that generate geometry for the 3D modeling system. The plug-in can provide scripting tools to control modeling commands for the 3D modeling system.

The embedded interface 802 for the plug-in for a 3D modeling system can have the control panel 702 of visual elements or tools in some embodiments. The embedded interface 804 for the 3D modeling system can correspond to the visualization of a garment 704 in some embodiments.

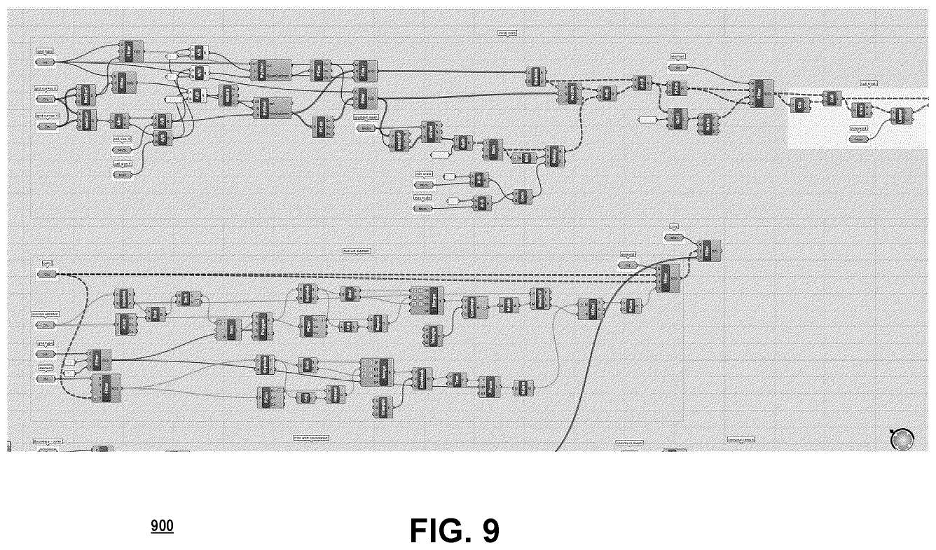

FIG. 9 shows part of a process 900 for generating or modifying garment patterns. The process shows an example logic flow to control operates for different processes. Each of the boxes in FIG. 9 represents a value or calculation operation to define relationships between input and output data for computations for the garment patterns. The data can be guest data or preference data, for example. The components of the process 900 can be logic gates, for example. The interconnection of gates to perform a variety of operation can be referred to as logic flow for the process 900. The lines represent connections between different values or calculations. The leftmost boxes, with no lines leading into their left-hand sides are inputs. These inputs may be, for example, data collected by sensors 106, personalization data, such as user fit preference, or customization data, such as parameters chosen by a user at an interface. The boxes with lines on both their left-hand and right-hand sides are calculations. Each calculation calculates a result based on one or more input parameters. These input parameters may be an input or the result of another calculation. The process 900 can generate gradient values based on the logic flow, for example. The process 900 is configurable to define different relationships between data processed by the system to generate different computations for the garment patterns. The elements or gates can relate to grid types, grid curves, cells, boundaries, cups and so on. The operations can involve merging, cleaning, filtering, or sorting the data, for example. An interface can display graphical elements for the components and connections to configure and define different logic flows for the computations of data for the garment pattern. The interface can be used to create new logic flows or modify existing logic flows for the process 900. The process 900 corresponds to instructions executable by a processor.

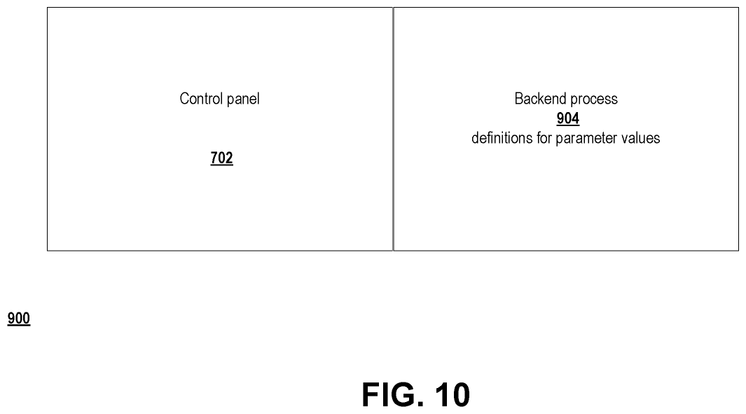

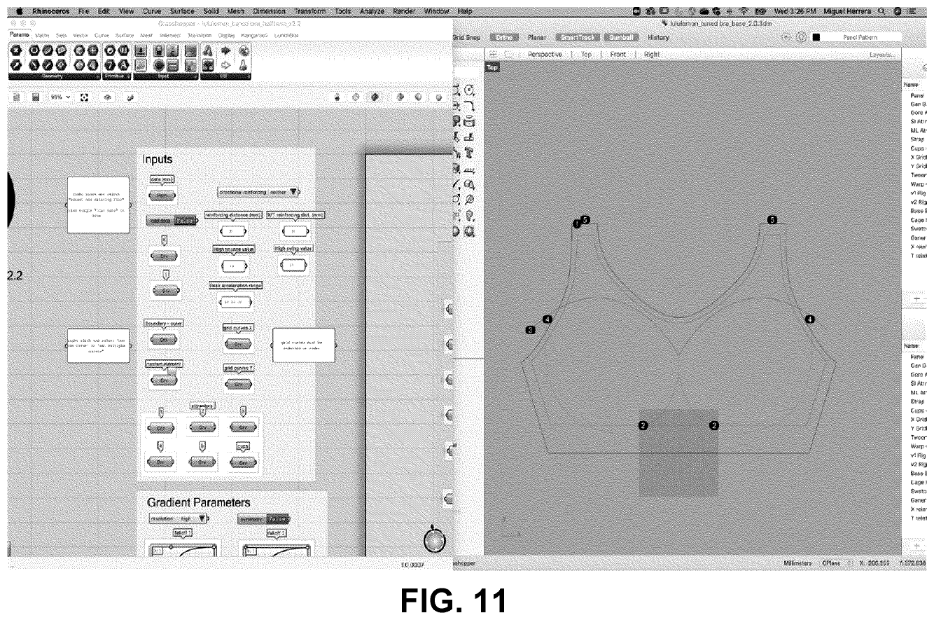

FIG. 10 shows an interface for generating or modifying garment patterns with a control panel 702 and visual elements corresponding to backend process for computing parameters and values using the user data. The control panel 702 can be used to update the process for computing parameters and values. For example, the parameters and values for lateral displacement of the wearer's breasts (swing) during normal physical activity, the vertical displacement of the wearer's breasts (bounce) during normal physical activity. The control panel 702 of tools displays various parameters and fields with the different parameter values computed from the user data. The control panel 702 of tools can receive updated values to customize the garment and associated pattern files. For example, the user data may specify corresponding values for the directional reinforcement.

FIG. 11 shows an example interface for generating or modifying garment patterns with a gradient optimization component, in which attractor curves are generated. The interface has a control panel of tools including input parameter values computed by input data from sensors. For example, the interface can import data from any sensor in .SVG form. The interface has a control panel of tools including input parameter values for attractor curves. The interface can import or create any attractor curves which in turn control the gradient of the material for the garment or product. The interface has a visualization of a pattern. The interface has a control panel of tools including tools for the input of different pattern pieces. The interface can import or create different pattern pieces. The interface has a visualization of the pattern with attractor curves. The different attractor curves can be marked with different reference values or numbers, for example. The interface has a control panel of tools to edit or adjust the parameter values for the attractor curves and in response the visualization of the pattern with attractor curves updates based on the adjusted parameter values.

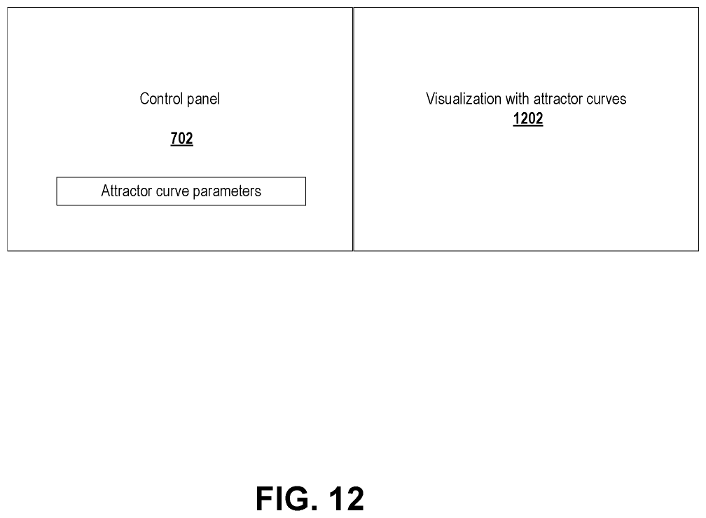

FIG. 12 shows an example interface for generating or modifying garment patterns with a control panel 702 and a visualization 1202 of a pattern with attractor curves. The control panel 702 can have a gradient optimization component to control properties of attractor curves. The control panel 702 includes input parameter values and triggers to upload input data from sensors. For example, the control panel 702 can import data from any sensor in .SVG form. The control panel 702 includes tools to change input parameter values for attractor curves. The control panel 702 can import or create any attractor curves. As noted, the attractor curves in turn control the gradient of the material for the garment or product. The interface has a visualization 1202 of a pattern. The control panel 702 has tools for the input of different pattern pieces. The control panel 702 can import or create different pattern pieces. The interface has a visualization 1202 of the pattern with attractor curves. The different attractor curves can be marked with references that correspond to parameters that can be adjusted by the control panel 702. The control panel 702 can edit or adjust the parameter values for the attractor curves and in response the visualization 1202 of the pattern with attractor curves updates.

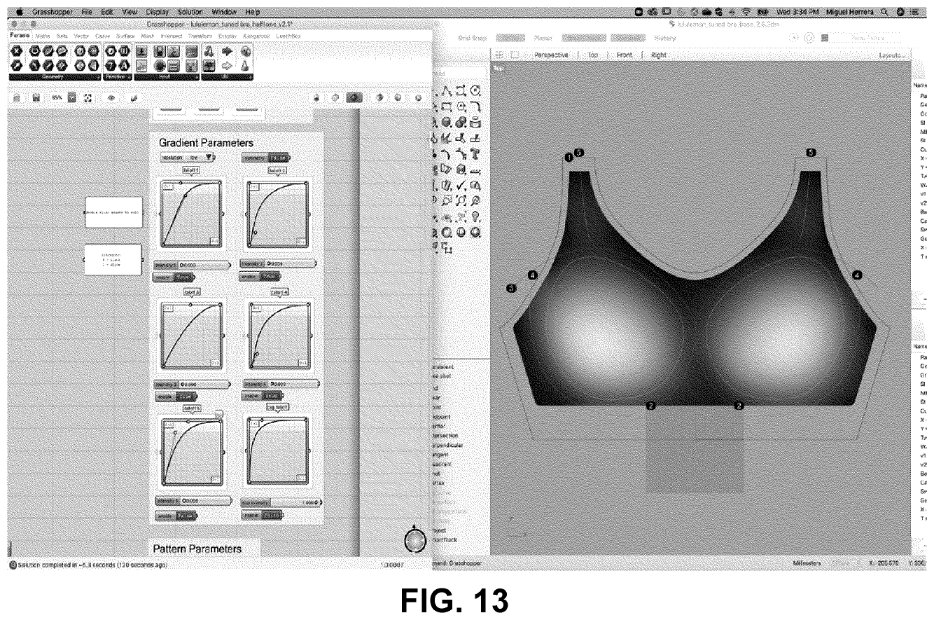

FIG. 13 shows an example interface for generating or modifying garment patterns with a gradient optimization component. The interface can generate gradient data and display parameter values for different gradient properties. The gradient optimization component has different tools to adjust the gradient. The interface has a visualization of the pattern with visual elements corresponding to different gradients in the material for the garment. The interface has a visualization of the pattern with visual elements corresponding to different gradients for each attractor curve. The interface has a control panel of tools including gradient controls to edit or adjust the values for gradient parameters and attractor curves. In response, the visualization of the pattern with attractor curves updates based on the adjusted parameter values to show different gradients in the material. The gradient controls the allocation and intensity of the objects that create the mesh of material for the garment. The gradient intensity and ‘falloff’ is driven by the attractor curves. The gradient intensity is of a measure of the magnitude of a gradient. The gradient falloff is a measure of how quickly the gradient value decreases with increasing distance from an attractor curve. The gradient associated with a given attractor curve may be calculated as G=I−F(D), where G is the gradient, I is the intensity, and F is the falloff, as a function of D, distance from the attractor curve, and where F(0)=0. In a garment with multiple gradients a single parameter (e.g. elastic modulus), the overall gradient of the garment for that parameter is the sum of the individual gradients, the intensity of the individual gradients represents the weight of influence of a given attractor curve on the overall gradient, and the falloff represents how a given attractor curves' influence on the overall gradient at a point changes the further that point is from the attractor curve. The gradient intensity and gradient falloff can be controlled individually for the different attractor curves or points. For example, the gradient falloff for one attractor curve may be linear, the gradient falloff for a second curve may be a step function, and the gradient falloff for a third curve may be a piecewise function that is a linear function for close to the attractor curve, and quadratic function further from the attractor curve. If the attractor curve is moved or modified, then the visualization of the garment with the gradient will update accordingly. The interface can control which area of the pattern is being affected by the parametric pattern.

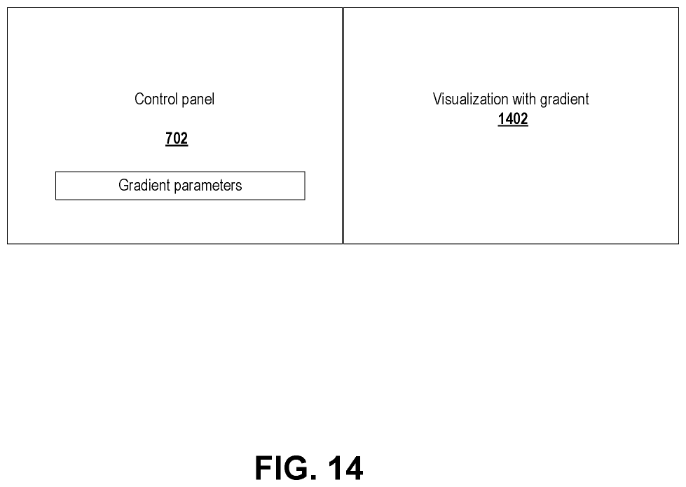

FIG. 14 shows an interface for generating or modifying garment patterns with a control panel 702 and a visualization 1402 with gradient parameters. The control panel 702 receives input for generating or modifying gradient parameters to provide a gradient optimization component. The control panel 702 can receive gradient data and display parameter values for different gradient properties. The control panel 702 has gradient optimization component with different gradient parameters for attractor lines to adjust the gradient. The visualization 1402 of the pattern has visual elements corresponding to different gradients in the material for the garment. The visualization 1402 has visual elements corresponding to different gradients for each attractor curve. The control panel 702 has gradient controls to edit or adjust the values for gradient parameters and attractor curves. In response, the visualization 1402 of the pattern with attractor curves updates based on the adjusted parameter values to show different gradients in the material. The gradient defines the allocation and intensity of the objects that create the mesh of material for the garment. The gradient intensity can be controlled individually for the different attractor curves or points using the control panel 702. If the attractor curve is moved or modified then the visualization 1402 of the garment with the gradient will update accordingly. The control panel 702 can control which area of the pattern is being affected by the parametric pattern.

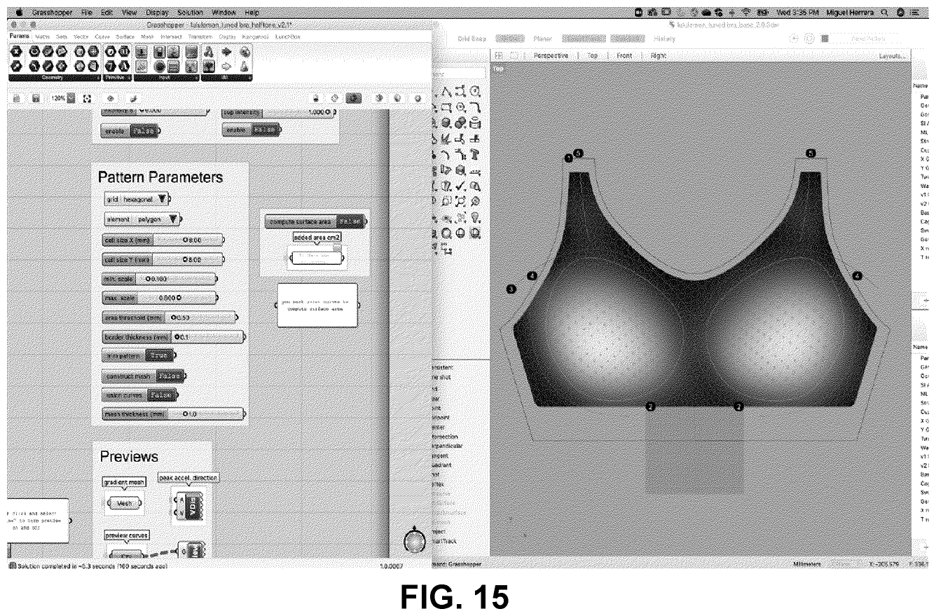

FIG. 15 shows an example interface for generating or modifying garment patterns with a visualization of pattern parameters with an optimization component. The pattern parameter controls allow for the control of the parametric pattern that is being driven by the gradient. The objects or shapes of the material for the garment will be displayed differently based on the intensity of the gradient. For example, the darkest dark of the visualization can be a first state and the lightest light of the visualization can be a second state. Example pattern parameters include grid for objects or cells of the material, element shape for the objects or cells of the material, shape distortion, shape rotation, cell size, cell size overlap, cell scale, border thickness, trim pattern, mesh thickness, and so on.

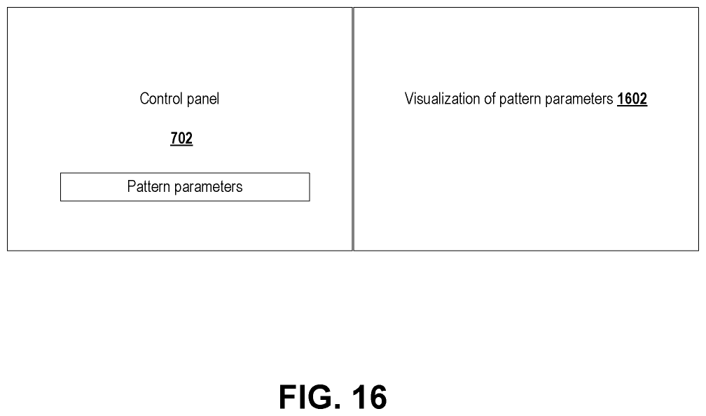

FIG. 16 shows an example interface with a control panel 702 for generating or modifying garment patterns with a visualization 1602 of pattern parameters. The control panel 702 has pattern parameter controls to control values of the parametric pattern that is being driven by the gradient. The objects or shapes of the material for the garment will be displayed differently in the visualization 1602 based on the intensity of the gradient. The control panel 702 can have different pattern parameters such as grid for objects or cells of the material, element shape for the objects or cells of the material, cell size, cell scale, border thickness, trim pattern, mesh thickness, and so on.

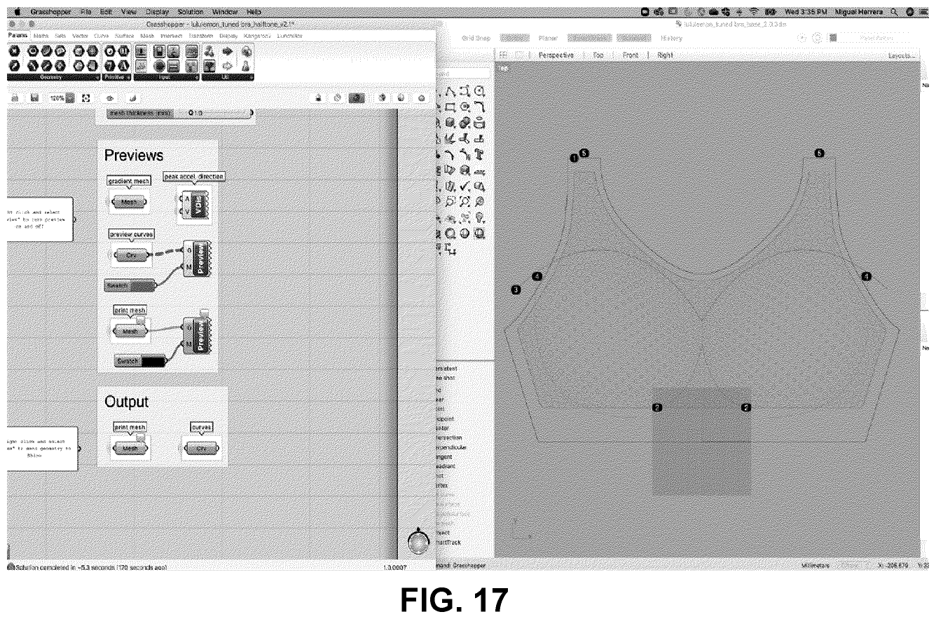

FIG. 17 shows an example interface for generating or modifying garment patterns with a preview visualization for the customization process for generating or modifying garment patterns. The preview can be used to generate a preview visualization of the personalized garment before a pattern is exported. The interface has a menu that provides different preview options such as showing the gradient and objects. In order for the personalized garment pattern to be usable by a 3D modeling system or manufacturing system, an output file for the personalized garment pattern is generated based on the parameters and values.

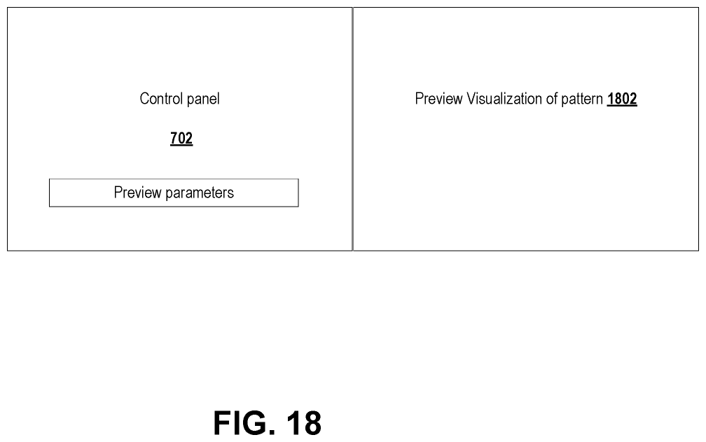

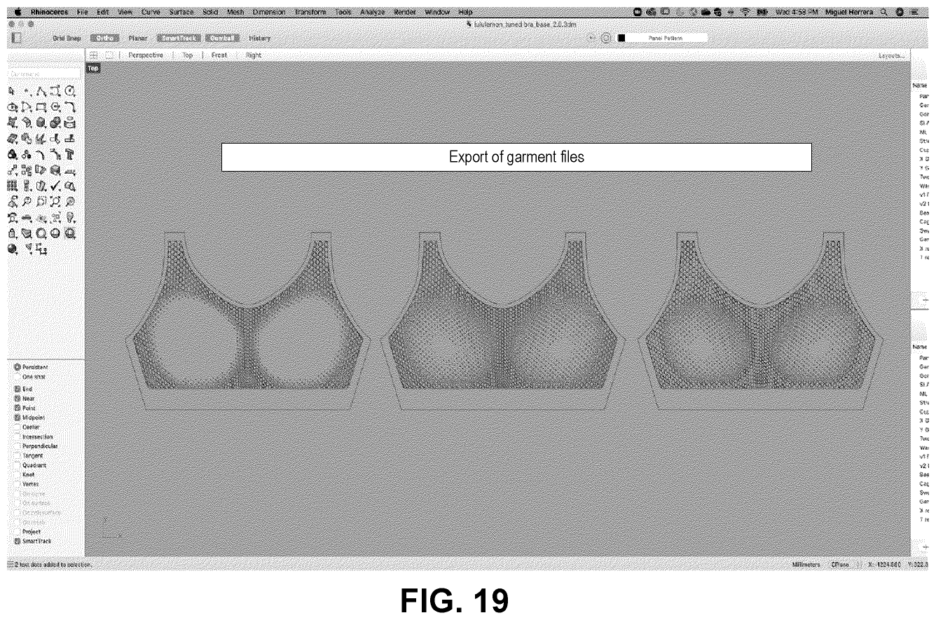

FIG. 18 shows an example interface with a control panel 702 having preview parameters and a preview visualization 1802 as part of the customization process for generating or modifying garment patterns. The control panel 702 can be used to generate a preview visualization 1802 of the personalized garment before a pattern files are created and exported. The control panel 702 has a menu with preview parameters to define different preview options such as showing the gradient and objects.

FIG. 19 shows example interface with a visualization of generated or exported garment pattern files. The interface can trigger the generation and transmission of the garment pattern files. For example, the interface can trigger the generation and transmission of the garment pattern files to a 3D modeling system or manufacturing system. The garment pattern files include an output file for the personalized garment pattern based on the parameters and values.

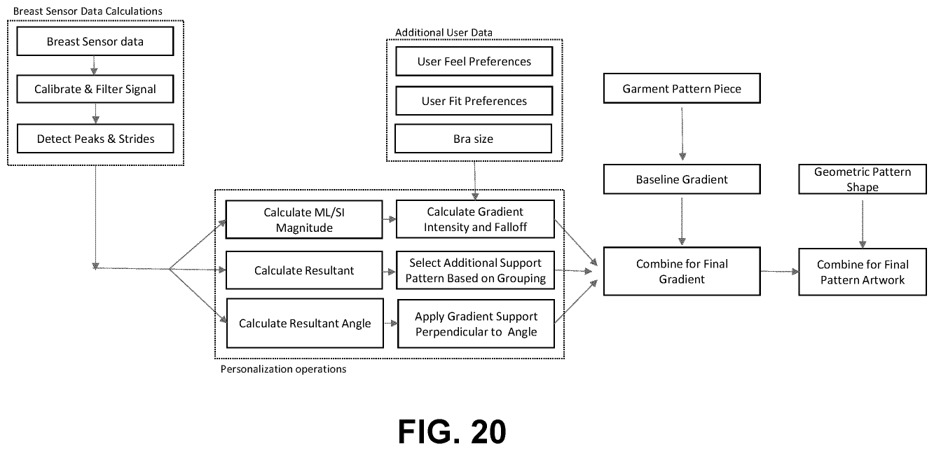

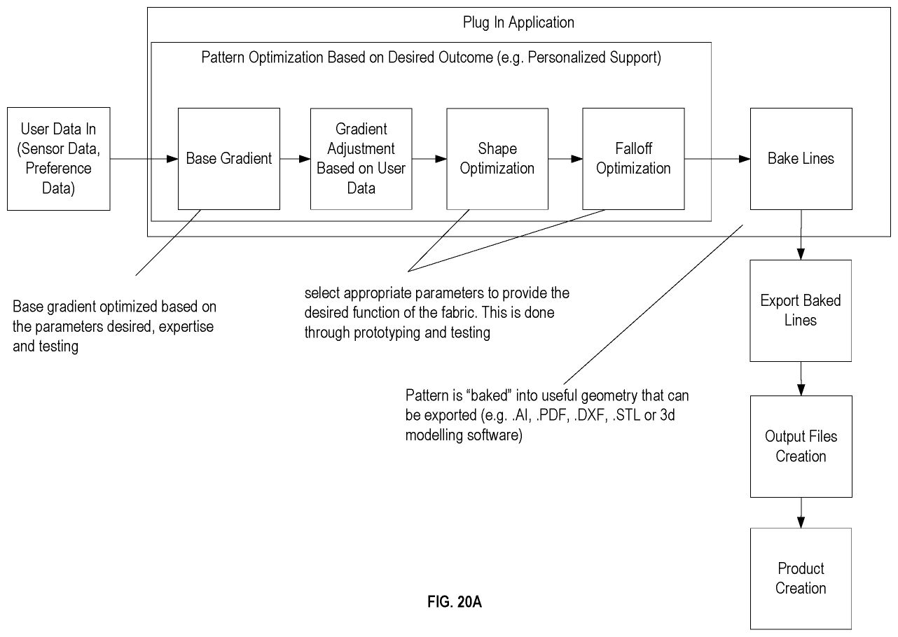

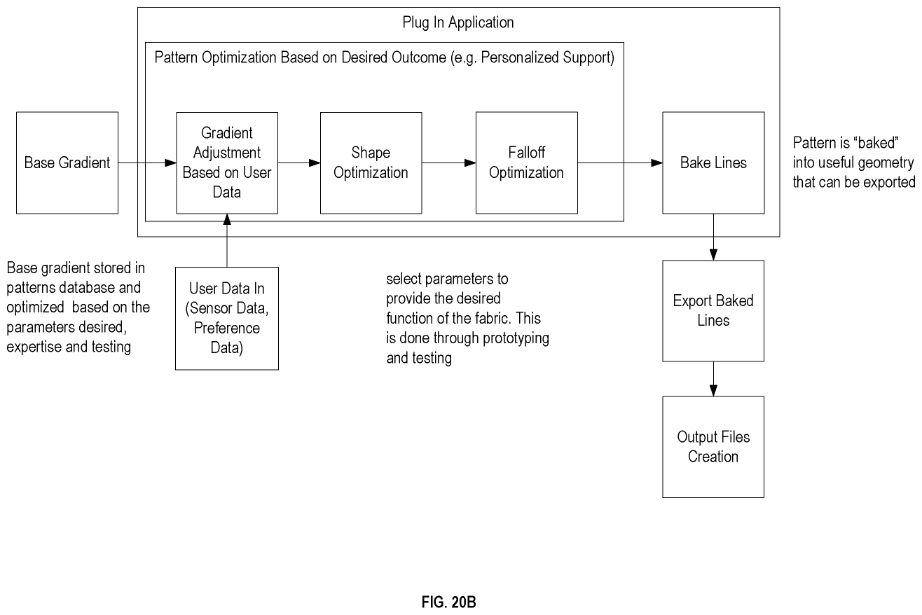

FIG. 20 shows an example method of generating a garment, in this case a sports bra, using the parametric pattern of the plug-in application for a 3D modeling system. FIG. 20 shows a flow diagram of the steps that may be taken to generate a product for the user using the parametric pattern, sensor data representing physical and behaviour characteristics, and preference data representing user preferences. The steps shown in FIG. 20 are exemplary in nature and the order of the steps may be changed and steps may be omitted and/or added without departing from the scope of the disclosure. While the steps shown in FIG. 20 are for generating a sports bra, similar steps may be used to generate other types of garments.

In some embodiments, the garment pattern of pattern database 104 is for a bra. The user data includes breast movement data. The extracted measurement and movement attributes can be side to side acceleration, up and down acceleration, displacement and angle of peak acceleration. In some embodiments, the sensor data includes breast sensor data. The sensors 106 can be proximate to or positioned on a user to collect breast sensor data, for example. The design system 102 calibrates and filters (as example pre-processing operations) signals from the breast sensor data and detects peaks and strides in the signals. In some embodiments, the measurement and movement attributes are magnitude, resultant, resultant angle. The design system 102 uses the magnitude to compute gradient metrics, uses the resultant to select movement group for a support pattern, and uses the resultant angle to apply gradient support. In some embodiments, the design system 102 computes the gradient metrics using the user preference data. In some embodiments, the design system 102 computes a baseline gradient using a product pattern piece, and a final gradient using the baseline gradient, the gradient metrics, the gradient support, and the support pattern.

An example process is provided in FIG. 20 to illustrate aspects of embodiments described herein. The process begins, for example, by the design system 102 retrieving user data collected by sensors 106. In the example of generating a sports bra, the system 102 may retrieve data relating to the motion of the user's breasts while performing physical activity to compute values for the parametric pattern. This data is collected by one or more sensors 106, such as motion detection sensors worn by the user or a camera that is part of an immersive hardware 108 device.

User data collected by the sensors 106 may undergo pre-processing. For example, the sensor data may be calibrated to provide a mapping from sensor output values to meaningful units, and sensor data may be filtered to separate meaningful data from background noise. The user data may also be processed to detect useful parameters of the data, such as peaks and strides. For example, in the case of breast movement data, data relating to peak acceleration may be of particular interest. Peak detection may be used to detect these peaks and transmit peak acceleration data as a distinct data set.

The user data is used, either directly or after pre-processing, to calculate physical characteristics of the user. These characteristics may include breast accelerometry (or a user's signature movement for different body portions) metrics such as mediolateral (side to side) acceleration, superior-inferior (up and down) acceleration, mediolateral displacement, superior-inferior displacement, angle of peak acceleration, displacement, sweat rate, physical signature, and so on. For example, raw or pre-processed motion detection sensor data may be used to calculate the magnitude of the user's mediolateral and superior-inferior acceleration, the magnitude of the resultant acceleration, and the angle of the resultant acceleration. The system can compute a signature movement for the user based on the user data. The user data can define lateral displacement and acceleration (swing), and the vertical acceleration and displacement (bounce).

The design system 102 can also collect additional user data from sources other than the sensors. This additional user data may include, for example, bra size, activity preference, fit preference, feel preference, emotional signature, and so on. In some embodiments, the design system 102 also retrieves parametric pattern data from the patterns databases 104.

For a personalized bra, the sensors 106 capture breast accelerometry data and feel preferences as input data for the pattern to compute manufacturing properties to be laser cut, burn out, applied or screen printed, jet printed or manufactured by some other design process to give specific mechanical properties to achieve movement management and desired feel state personalized for the user. The system 102 can generate associated files for automating assembly and manufacturing of the product. For example, the manufacturing of the product can include manufacturing of the pattern only, such as printing, laser cut, burn out or knitting the pattern sheet or piece alone and then applying it to a garment by any thermal, chemical or mechanical process (e.g., bonding, gluing, sawing). In some embodiments, the manufacturing of the product can include manufacturing the product with the designed pattern at the same time. For example, the product with the designed pattern (e.g., final garment) can be 3-D printed using any suitable additive manufacturing process or the pattern can be printed (e.g., jet printed, screen printed) directly on the garment or the product with the designed pattern can be knitted, such as for example, that the designed pattern is defined by different yarn/yarns combination from the rest of the garment or it is defined as double-layer knitting zone which is seamlessly knitted into the rest of the product which can be single layer knitted. The product is assembled and shipped to the user. The personalized bra and the associated code files can be pattern and material files generated by a 3D modelling system coupled to or in communication with the system 102.

Based on the user data, a base garment pattern is optimized. The base garment pattern comprises parametric pattern data from the patterns database 104. This base product pattern is used to create a baseline gradient, which is then combined with optimizations based on the user data to create a final gradient.

The user data can include data indicating the user's desired outcome, functionality, or result. For example, in the case of a bra, the desired outcome may be personalized support for the user's breasts. The base garment can have default parameter values such as a base gradient. The default parameter values can be updated based on testing.

The interface 112 can receive the desired outcome as input data as part of the personalization process for the garment or product. The design system 102 can receive the desired outcome from interface 112. The optimization of the base pattern for the desired outcome can involve different operations by design system 102.

The base gradient is optimized on desired parameters (e.g. optimized support). The interface 112 can receive the desired parameters as input data as part of the personalization process for the garment or product. The design system 102 can optimize the base gradient. The base gradient and desired parameters can be generated by the design system 102 using historical data, template patterns, testing data, and learning based on feedback.

The design system 102 computes any gradient adjustment based on user data. For example, the user data can be breast accelerometry data extracted or generated from sensor data can be used for computing any gradient adjustment. For the bra example, the magnitude of the mediolateral and superior-inferior acceleration can be calculated and used in conjunction with bra size and user preference data (such as feel preference data and fit preference data) to calculate the gradient intensity and ‘falloff’, which measures the range of the intensity of the gradient. Breast accelerometry data can also be used to compute peak acceleration (resultant) which can be used to select additional support patterns based on support solutions defined for specific movement groups. For example, the movement groups can be “high swing and high bounce movement group, low swing and high bounce group, or high swing and low bounce group, low swing and low bounce group, and high swing and high bounce group. The resultant data is grouped into one of the ‘movement groups’ which defines additional support components from records in a database. For the bra example, the specific movement group may determine whether additional X or T reinforcing should be added at the gore location of the bra. The mediolateral and superior-inferior acceleration can also be used to determine the angle of peak acceleration (resultant angle), which can then be used to determine the angle of application of the gradient (intensity and falloff). For example, the gradient would be applied perpendicular to the direction of the peak acceleration for the greatest support. The mediolateral and superior-inferior acceleration can also be used to determine the angle of peak acceleration (resultant angle), which can then be used to determine whether X or T reinforcing should be added. This can be determined based on whether the value is above a ‘high swing’ or ‘high bounce’ input or threshold, for example. The X or T reinforcing can be used to provide extra reinforcement or gradient in the centre of the bra. The angle is used to add directional reinforcing (extra gradient) perpendicular the acceleration of peak acceleration.

The final optimized gradient is then combined with a geometric pattern shape, for example, a hexagonal grid pattern, to create a final pattern artwork to be used to manufacture the sports bra.

FIG. 20A shows an example method of generating a garment using the parametric pattern of the plug-in application for a 3D modeling system. FIG. 20A shows a flow diagram of the steps that may be taken to generate a product for the user using the parametric pattern, sensor data representing physical and behaviour characteristics, and preference data representing user preferences. The steps shown in FIG. 20 are exemplary in nature and the order of the steps may be changed and steps may be omitted and/or added without departing from the scope of the disclosure.

The process begins, for example, by the design system 102 retrieving user data and parametric pattern data from the patterns databases 104. For example, if the garment being designed is a sports bra, the system 102 may retrieve data relating to the of the user's breasts while performing physical activity to compute values for the parametric pattern.

The user data is may include breast accelerometry (or a user's signature movement for different body portions) data such as mediolateral (side to side) acceleration, superior-inferior (up and down) acceleration, mediolateral displacement, superior-inferior displacement, angle of peak acceleration, displacement, sweat rate, bra size, activity preference, fit preference, feel preference, physical signature, emotional signature, and so on.

The design system 102 can compute manufacturing properties to be laser cut, burn out, applied, screen printed, jet printed or manufactured by some other design process to give specific mechanical properties to achieve movement management and desired feel state personalized for the user. The system 102 can generate associated files for automating assembly and manufacturing of the product. The product is assembled and shipped to the user. The garment and the associated code files can be pattern and material files generated by a 3D modelling system coupled to or in communication with the design system 102.

Based on the user data, a base garment pattern is optimized. The base garment pattern comprises parametric pattern data from the patterns database 104. This base product pattern is used to create a baseline gradient, which is then combined with optimizations based on the user data.

The user data can include data indicating the user's desired outcome, functionality, or result. For example, in the case of a bra, the desired outcome may be personalized support for the user's breasts. The base garment can have default parameter values such as a base gradient. The default parameter values can be updated based on testing.

The interface 112 can receive the desired outcome as input data as part of the personalization process for the garment or product. The design system 102 can receive the desired outcome from interface 112. The optimization of the base pattern for the desired outcome can involve different operations by design system 102.

The base gradient is optimized on desired parameters (e.g. optimized support). The interface 112 can receive the desired parameters as input data as part of the personalization process for the garment or product. The design system 102 can optimize the base gradient. The base gradient and desired parameters can be generated by the design system 102 using historical data, template patterns, testing data, and learning based on feedback.

The design system 102 processes the user data to determine what modifications should be made to the base garment pattern in order to generate an optimized gradient. For example, the base gradient may be modified based on acceleration data to provide more support in areas of high acceleration. The angle of peak acceleration may be used to provide directional reinforcing perpendicular to the direction of peak acceleration. The type of reinforcing used may be determined by whether the user's breasts experience more lateral or vertical acceleration at a given location. As will be discussed below, the user may provide customization data to guide the optimization process.

The design system 102 implements shape optimization and falloff optimization. Once the optimized gradient is determined, the mesh of shapes making up the garment must be determined. The shapes are areas of structural strength in a garment, and the falloff rate and the interaction between shapes determines the characteristics of the garment. The mesh of shapes is optimized to provide the desired function of the fabric. As will be discussed below, the user may provide customization data to help determine the desired function and provide additional inputs to be considered as part of the optimization process. The design system 102 selects shape, size, falloff rate, and interaction between the shapes that will provide the desired outcome or function of the fabric or material. The interface 112 can receive shape parameters, size parameters, falloff rate parameters for transmission to the design system 102 in some example embodiments. The parameters can be used to set default values or thresholds for shape optimization and falloff optimization.

Once the garment pattern is optimized, the pattern is converted into a useful geometry that can be exported as files to other software programs, including a 3D modeling system. For example, the pattern may be exported to a format compatible with vector graphics software such as Adobe Illustrator, a PDF viewer, or a format suitable for viewing in 3D modelling software. This exported pattern is then used to manufacture the garment in accordance with garment manufacturing processes. The pattern exported may be in the form of files defining parameters for one or more of the attractor curves, the gradient, and the mesh of shapes.

FIG. 20B shows another example method of generating a garment using the parametric pattern of the plug-in application for a 3D modeling system. As shown, the plug-in application can implement some of the operations as described in FIG. 20A. The process can start with selection of the base gradient from the patterns database for provision to the plug-in application. These are examples and other operations can be implemented by the plug-in application to generate the output files for the pattern.

Turning to back FIG. 11, there is shown the example interface 700 from FIG. 7 at the step of the gradient optimization process, in which attractor curves are generated.

The control panel 702 at the left of the interface 700 shows inputs for generating attractor curves. At the top of the control panel 702 are inputs driven by data collected by sensors for example, the angle of maximum acceleration or the maximum observed lateral acceleration of the user's breasts. The control panel 702 also has attractor curve inputs. See also for example, FIG. 12. The user can create attractor curves or import pre-defined attractor curves. Pre-defined attractor curves may be stored as part of a product record stored in a pattern database 104.

The visualization 704 at the right of the interface 700 displays the flat base pattern along with attractor curves. The flat pattern may be imported from a base garment pattern or may be created by the user. The attractor curves are marked by numbers. As discussed above, the user may edit the attractor curves.

Referring to FIG. 13, there is shown the example interface 700 from FIG. 7 with gradient parameters that can be used during the step in the gradient optimization process, in which the gradient is generated based on the gradient parameters. As discussed, the gradient is influenced by the attractor curves, with the gradient reaching local maxima along the attractor curves and increasing in value with increasing distance from the attractor curves. The gradient parameters can be adjusted using control panel 702.

The control panel 702 at the left of the interface 700 shows inputs or controls for gradient parameters used by system 102 for generating the gradient from the attractor curves for the parametric pattern. The gradient can fall off at a different rate with increasing distance from each attractor curve. Furthermore, the intensity of each attractor curve's influence on the gradient may vary. The value of the local maximum reached at a given attractor curve (when disregarding the influence of other attractor curves) can vary. The inputs shown are intensity values and falloff curves corresponding to each attractor curve. These inputs, along with the attractor curves, can be used to calculate the gradient. The user can customize the input values, thereby customizing the gradient.

The visualization 704 at the right of the interface 700 displays the flat base pattern of a garment, in this case a sports bra, along with attractor curves and the gradient. As can be seen in FIG. 13, the gradient is high valued along the outside of the sports bra where there are several attractor curves close together and the gradient is low valued in each of the sports bra's cups where there are no attractor curves.

FIG. 14 is another example of a control panel 702 with gradient parameter controls that can impact the visualization of the gradient 1402.

Referring to FIG. 15, there is shown the example interface 700 from FIG. 7 during the shape optimization process. The material of the bra is composed of cells or objects having different shapes to create a geometry for the pattern of the garment. The pattern parameters can impact the cells or objects. The mesh of shapes is influenced by the gradient (and indirectly by the attractor curves), with the shapes being more densely distributed at higher gradient values.

The control panel 702 at the left of the interface 700 shows inputs for generating the mesh of shapes and configuring different pattern parameters to define properties of the garment. The user can select inputs to customize the mesh of shapes. For example, the user may be able to select the type of grid used (triangular, square, or hexagonal), the maximum and minimum shape sizes, the geometry of the individual shapes, and the spacing between the shapes. Data can be computed in relation to how shapes are interacting with each other, such as how much distance or lack there of there is between each individual shape to the ones around it. The less space the more “locked out” or least modulus the material will have, for example. These inputs, along with the gradient, are used to generate a mesh of shapes or geometry of the pattern, with the density of the shapes falling of as the gradient value decreases. Areas with higher shape density are less flexible and provide more support.

The visualization 704 at the right of the interface 700 displays the flat base pattern, in this case a sports bra, along with the attractor curves, the gradient, and the mesh of shapes. As can be seen in the example shown in FIG. 15, the shapes are densely packed together at high gradient values (and close to the attractor curves) and become less densely packed at lower gradient values, for example in the cups of the sports bra.

FIG. 16 is another example of a control panel 702 with pattern parameter controls that can impact the visualization of the pattern parameters 1602. The control panel 702 receives input from the pattern parameter controls and the input data is used to generated updated visualizations 1602 including different shapes of cells and different sizes of cells for the mesh of the garment pattern.

Turning to FIG. 17, there is shown an example of the interface 700 from FIG. 7 at the preview stage of the customization process, before the pattern is exported.

The control panel 702 at the left of the interface 700 shows options for viewing previews of the final pattern, and different properties of the final pattern, including gradient previews and mesh previews. The interface 700 may preview the attractor curves, the gradient, or the mesh of shapes. The user may also export the pattern in the form of files encoding attractor curves, the gradient, or the mesh of shapes.

The visualization 704 at the right of the interface shows the pattern preview. This preview is a representation of what an exported file would look like.

FIG. 18 is another example of a control panel 702 with preview parameter controls that can impact the visualization of the preview pattern 1802. The control panel 702 receives input from the preview parameter controls and the input data is used to generate updated visualizations 1802 including the mesh or gradient preview of the garment pattern.

Referring to FIG. 19, there is shown three exemplary exported garment patterns. Each garment pattern consists of files encoding a base pattern (the lines on the outside of the pattern) and a mesh of shapes. Each of the three garment patterns are based on the same base pattern for a sports bra. Each of the three garment patterns has different support properties. For example, the garment pattern on the left has a quick shape falloff and represents a garment that is more flexible. The pattern on the right has a relatively low shape falloff and represents a sports bra that provides more support.

Accordingly, FIGS. 20 and 20A illustrate example processes for the plug-in application to generate the files for the pattern using the parametric pattern and interface 700. The output pattern files optimized for the desired outcome are used to create the personalized product. These output files are used as instructions for how to manufacture the garment. The output files may include, for example, stitch patterning data, bill of materials data, and section views of the garment.

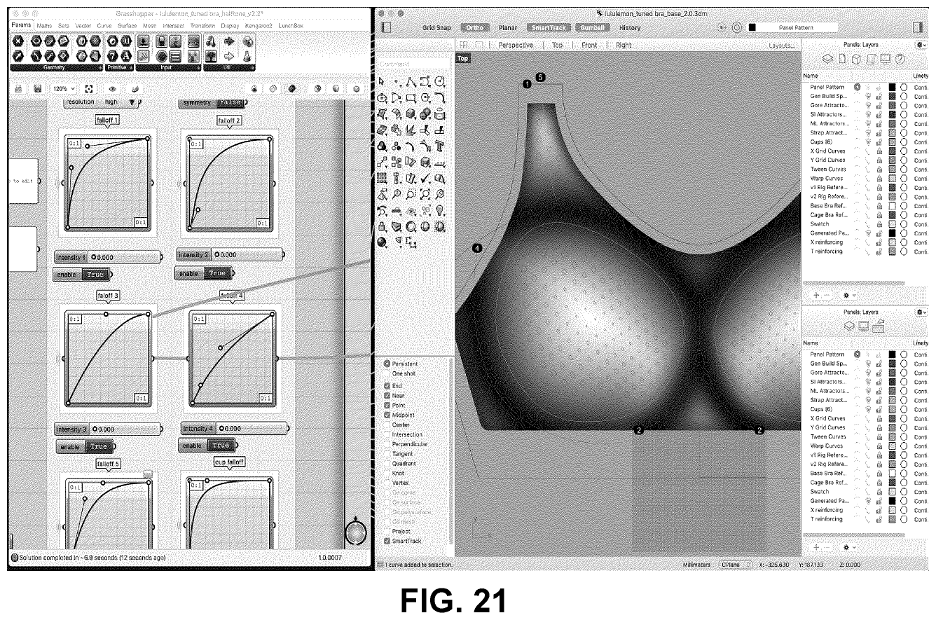

Turning to FIG. 21, there is shown an example interface for customizing garments. In the example interface, the control panel 702 has gradient falloff controls. The gradient falloff has been adjusted using the control panel 702 as compared to the example in FIG. 13. As a result, the pattern gradient has greater areas of low gradient, making the garment more flexible in some areas.

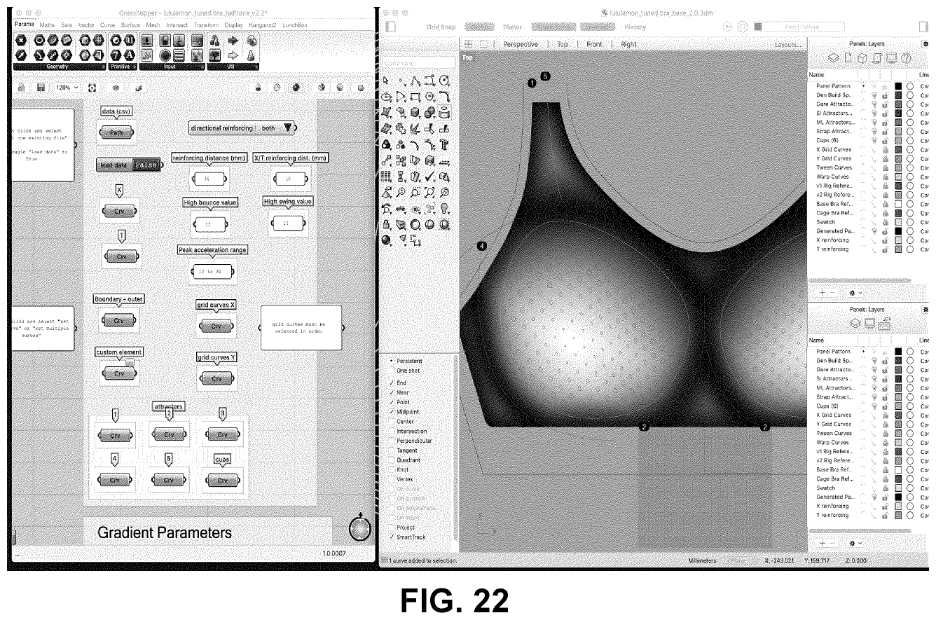

Turning to FIG. 22, there is shown an example interface for customizing garments. In this example, the pattern is a predefined base state. This gradient represents a base pattern generated without user customization. It may, for example, represent the “best for most” pattern for the garment, or the most easily personalized pattern for the garment. This can be used as a base gradient which can then be optimized for a desired outcome or by gradient parameter controls.

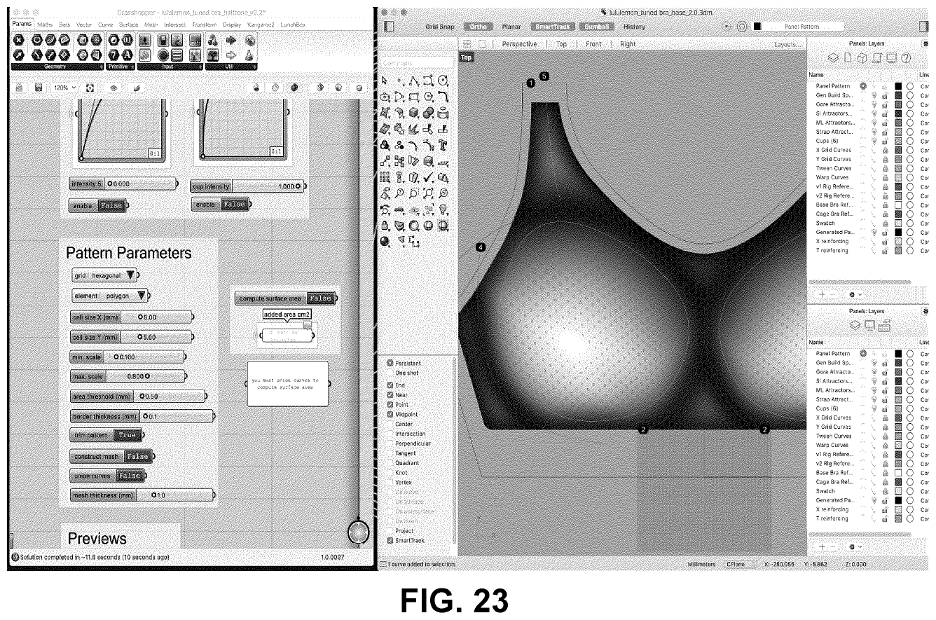

Turning to FIG. 23 there is shown an example interface for customizing garments. The gradient in this example is that shown in FIG. 22. However, customizations have been made to the pattern parameters to adjust the mesh of shapes. As compared with the mesh in FIG. 22, the shapes forming the mesh are smaller and have a higher density. This demonstrates how different meshes may can be generated from a single gradient using the parametric pattern and control panel 702.

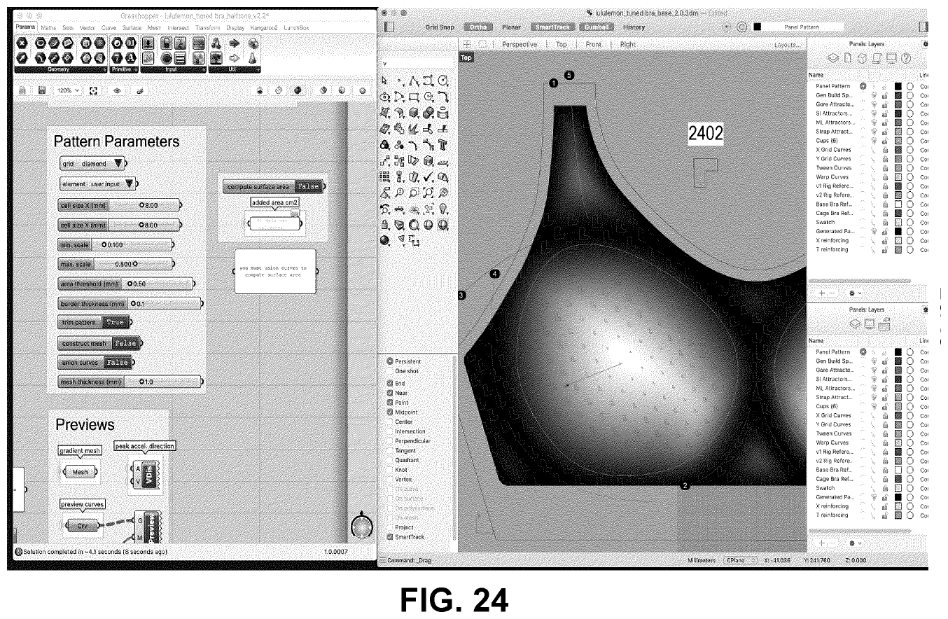

In some embodiments, the user may design a custom shape to act as a base unit in the mesh of shapes. Turning to FIG. 24, there is shown an example interface for customizing garments. As part of the pattern parameter controls, the interface 700 can be used to design an L shaped base unit 2402 as an example custom shape. The base unit shape is then used to form the mesh of shapes (or geometry) for the pattern with the shape being resized, rotated, and stretched as necessary to provide the desired garment properties.

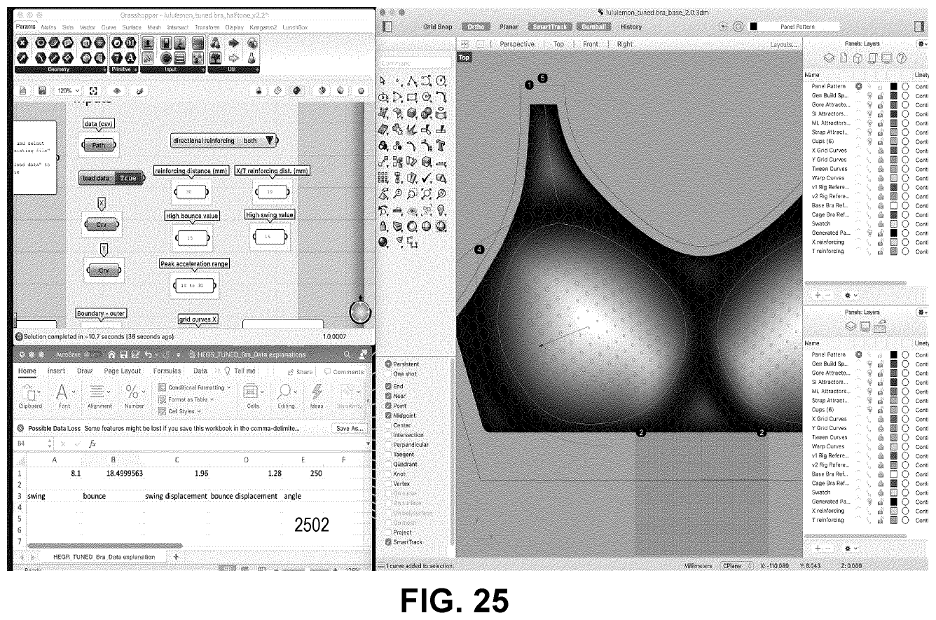

Turning to FIG. 25, there is shown an example interface for customizing garments alongside form fields for receiving or adjusting user data to generate the garment pattern. The arrow in the visualization indicates the angle of highest acceleration and indicates the direction in which the most support is required and may influence. In this example, the user data 2502 is indicative of high breast movement, which suggests that a high degree of support is required. The breast movement is defined by data values for swing, bounce, swing displacement, bounce displacement, and angle. Accordingly, the resulting garment has a mesh of shapes comprising large shapes with high density, and the gradient falls off slowly from the attractor curves. This example can indicate high movement data input. Additionally, the angle of highest acceleration is mostly in a mediolateral direction. Accordingly, the resulting garment has a gradient and mesh of shapes that falls off more quickly in the mediolateral direction.

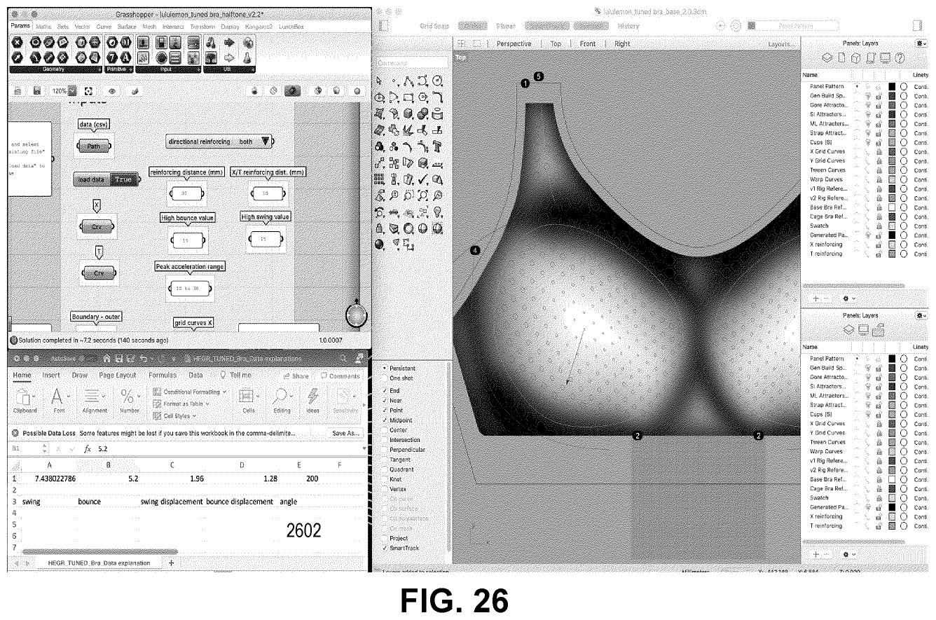

Turning to FIG. 26, there is shown an example interface for customizing garments alongside a spreadsheet outlining user data 2602 used to generate the garment pattern. This example can indicate low movement data input. The arrow in the visualization indicates the angle of highest acceleration. In this example, the garment base pattern, the attractor curves, and the base unit used in the mesh of shapes are identical to those in FIG. 25. However, the user data in this example, unlike the example shown in FIG. 25, is indicative of low breast movement. This may indicate that less support is required by the garment. Accordingly, the resulting garment has a gradient and mesh of shapes with faster falloffs. Additionally, the angle of highest acceleration in this example is more superior-inferior direction than in the example shown in FIG. 25. Accordingly, the resulting garment has a gradient and mesh of shapes that falloffs more quickly in the superior-inferior direction and more slowly in the mediolateral direction than in example in FIG. 25.

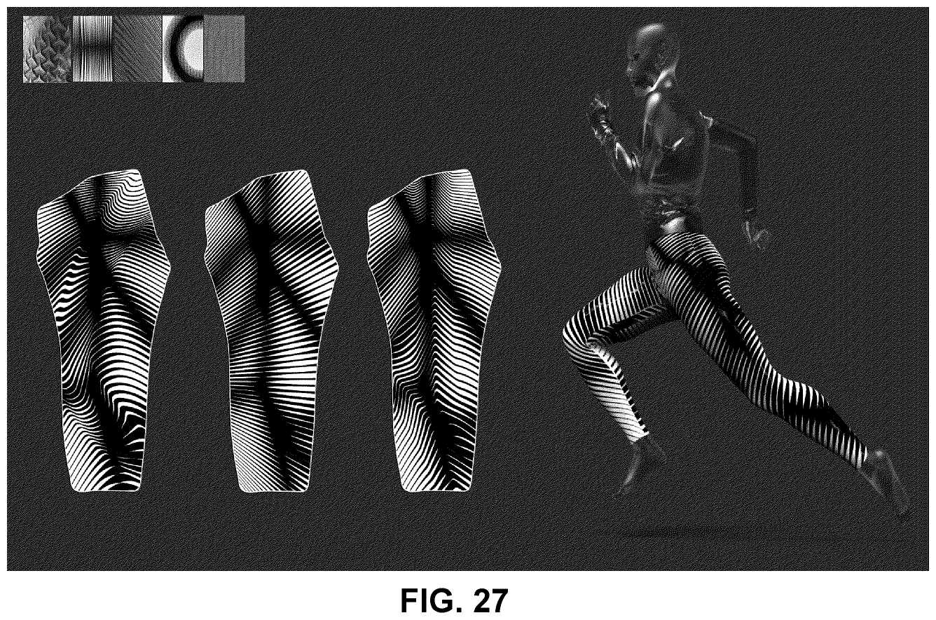

While in the previous examples the garment being generated was a sports bra, the system and method may be used to generate other types of garments. For example, FIG. 27 shows example garment patterns for pants or tights. As with the previous example interfaces showing visualizations of the custom garment, dark areas on the gradient are used to indicate areas of low elastic modulus and high support, while lighter areas are used to indicate high elastic modulus and less support. Based on user data and customization data, the gradient of the garment pattern may be personalized to suit the desired functionality of the pants. The pattern files for the garments define shapes of objects for the mesh and amounts of the objects within the same outer pattern piece. The pattern files for the garments also define different perimeter patterns that define outer pattern pieces, like the pants or bra example. There can be different perimeter patterns for different garments, and footwear.

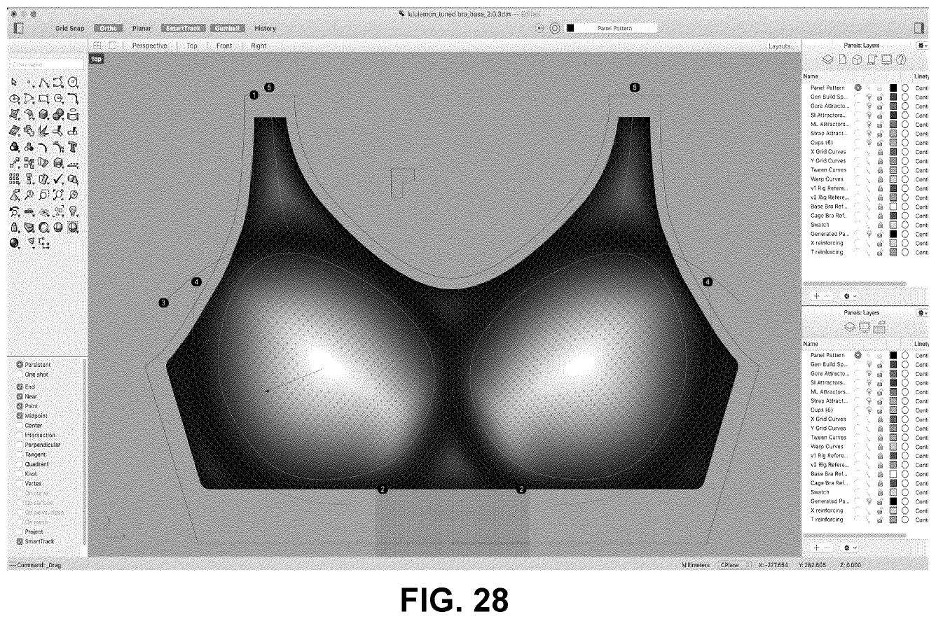

FIG. 28 shows an example visualization of a garment showing different shapes of objects and amounts of objects within the bra pattern. In this example, there is a significantly smaller cell size than in previous examples, which in turn leads to a much higher shape density. This example also demonstrates the use of a rectangular grid, as opposed to the hexagonal grid seen in previous examples. As discussed above, the shape grid may be hexagonal, rectangular, or triangular.

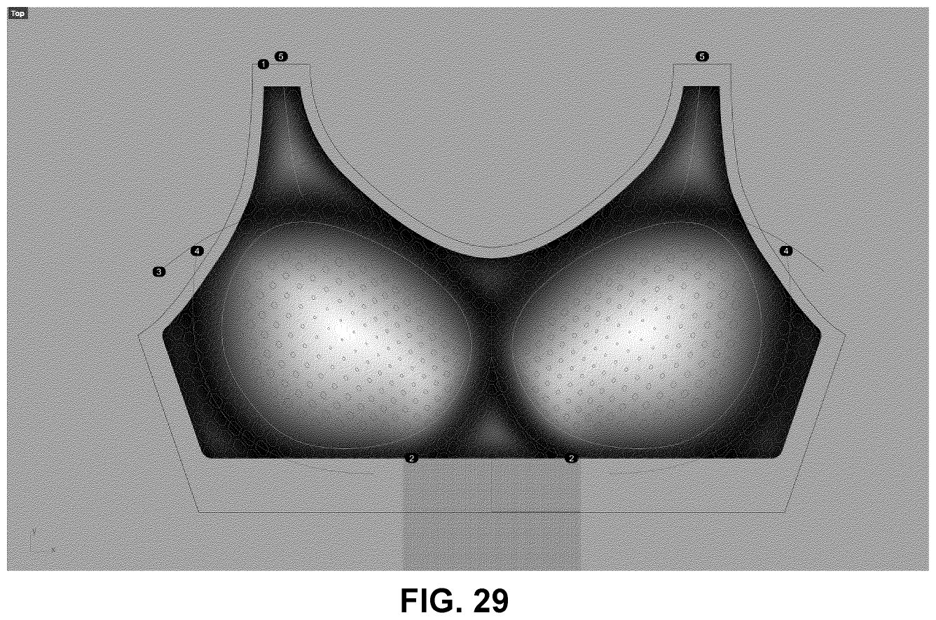

FIG. 29 shows an example visualization of a bra with objects to define a geometry for the garment pattern. The visualization shows a perimeter patter for the bra and attractor lines.

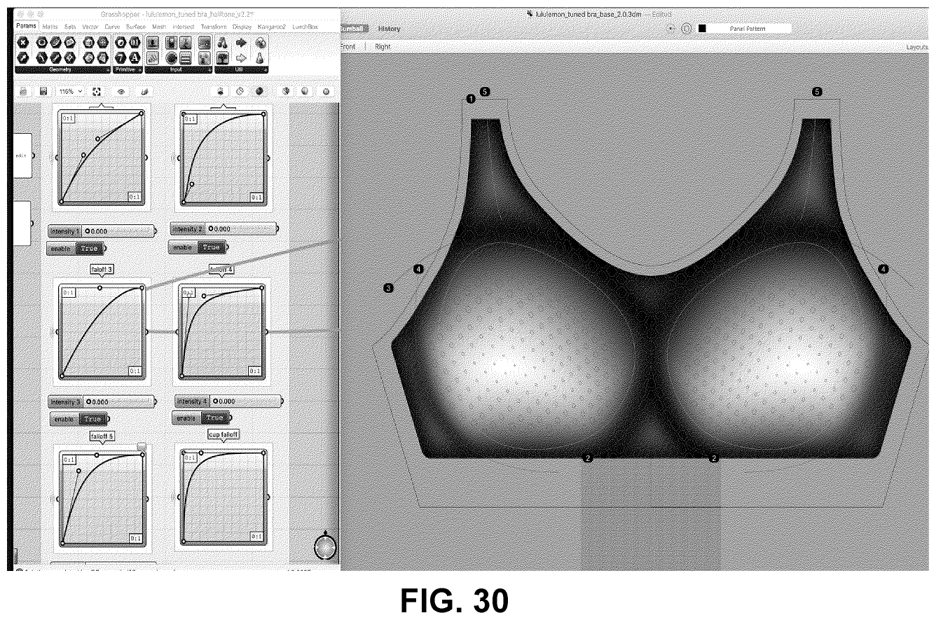

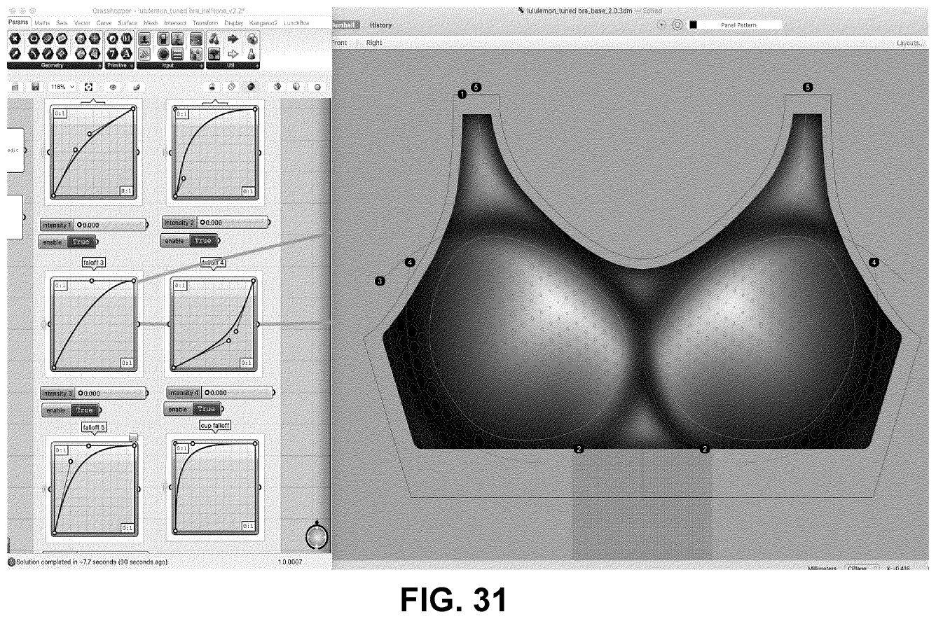

FIGS. 30 and 31 show example visualizations of a bra with a control panel of parameter controls including falloff parameter controls. The falloff parameter controls can be used to provide customization data for the falloff parameters. The system 102 updates the visualization in response to the customization data for the falloff parameters.

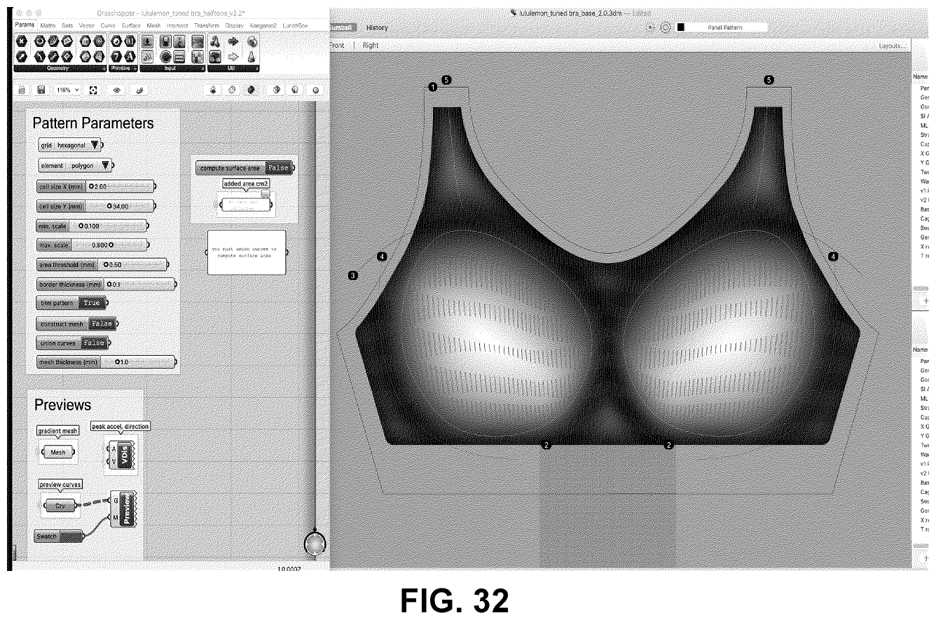

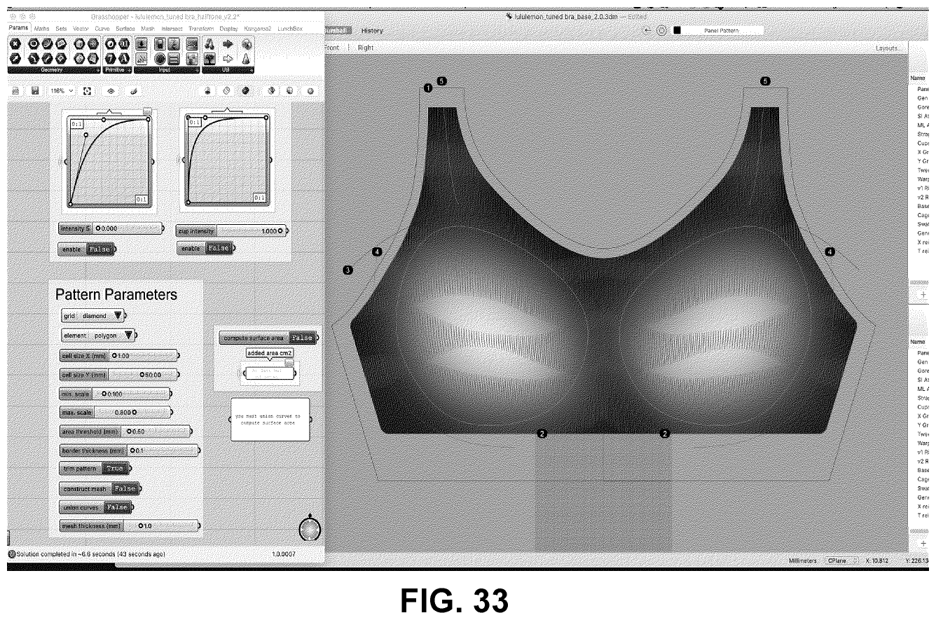

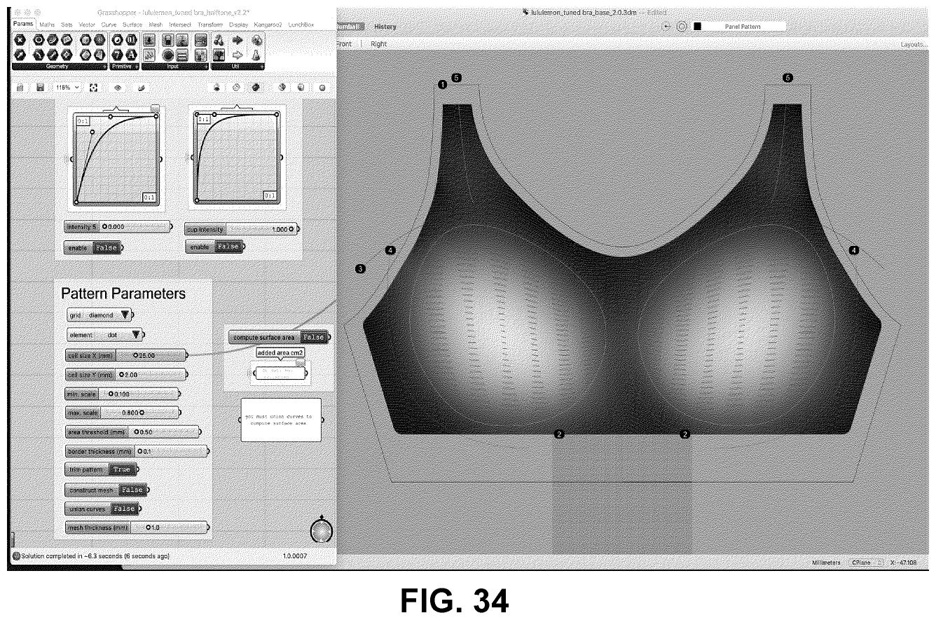

FIGS. 32, 33 and 34 shows an example visualization of a garment with a control panel of parameter controls including pattern parameter controls. The pattern parameter controls can be used to provide customization data for the pattern parameters. The system 102 updates the visualization in response to the customization data for the pattern parameters. In FIG. 32, the grid has been adjusted to create elongated shapes to provide control over the elastic modulus. In FIG. 33, the garment pattern from FIG. 32 has been adjusted by changing the cell size (decreased along the X-axis and increased along the y-axis), creating more vertical lines in the mesh, resulting in improved elastic modulus control in the superior-inferior direction. In FIG. 34 the grid properties have been adjusted to provide elastic modulus control in the mediolateral direction instead of in the superior-inferior direction.

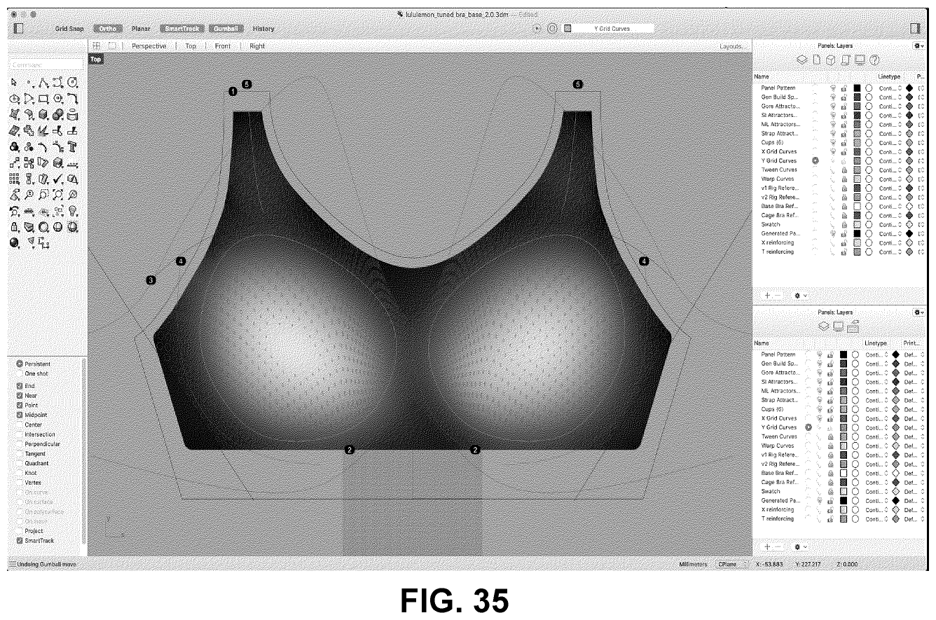

FIG. 35 shows an example visualization of a garment with different pattern pieces for a bra pattern. In this example, the curves driving the creation of the grid are not straight, demonstrating the effect of changing the lines on the resulting grid and the resulting properties of the garment.

Another example garment is pants or tights.

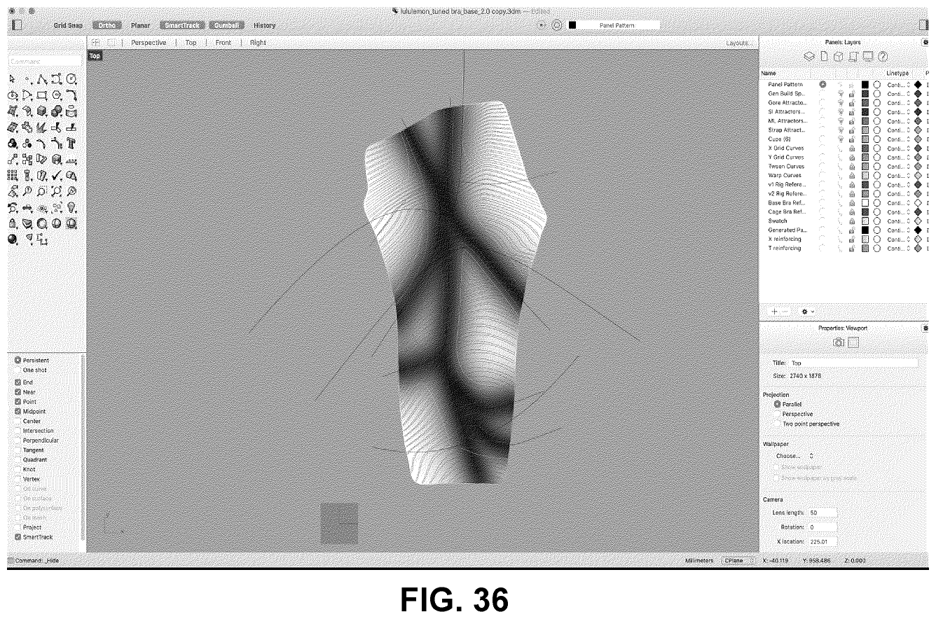

FIG. 36 shows an example visualization of a garment pattern piece for pants.

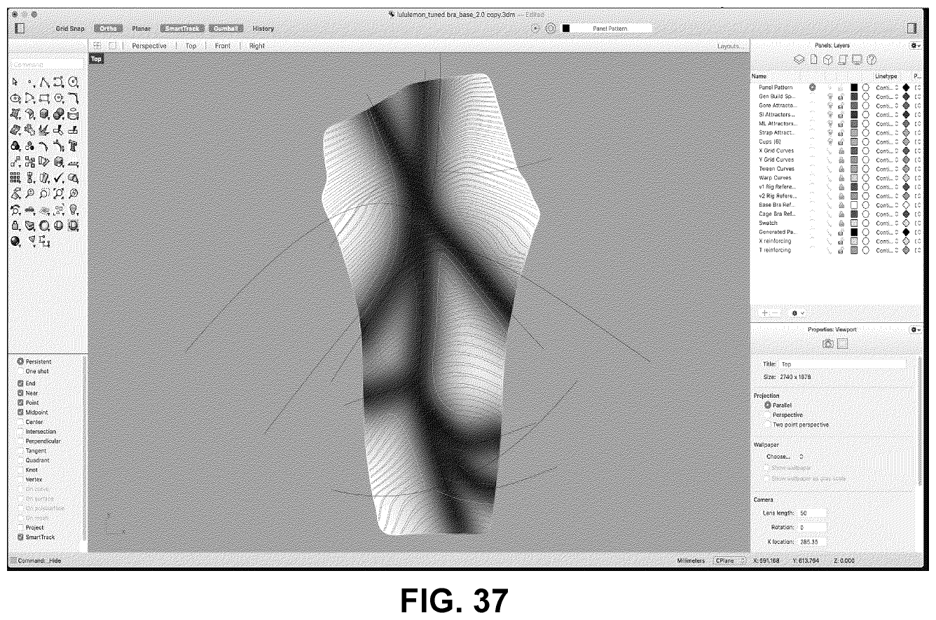

FIG. 37 shows an example visualization of a garment pattern piece for pants with attractor lines.

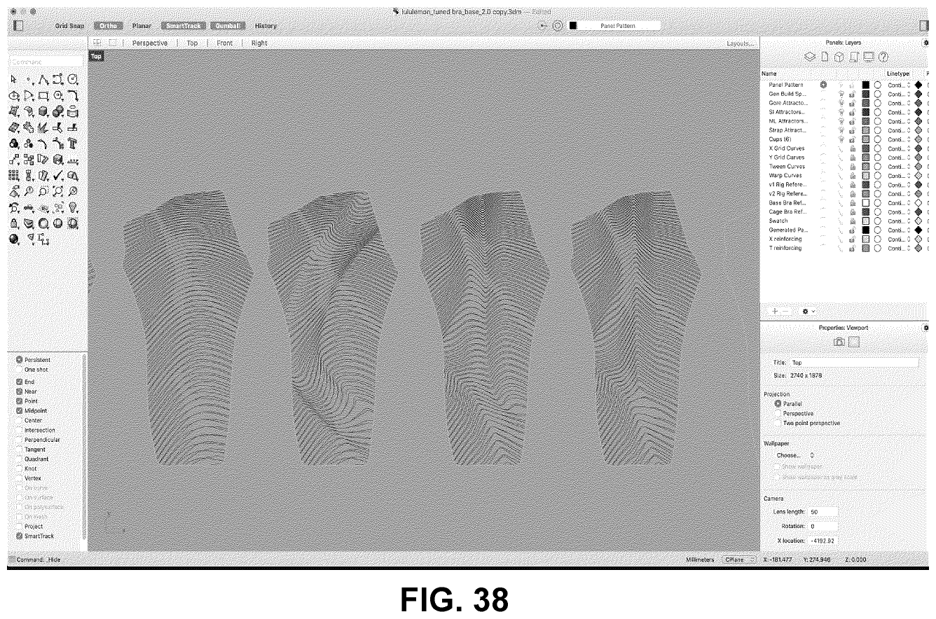

FIG. 38 shows an example visualization of garment pattern pieces for pants. Each of the pattern pieces are based on the same gradient, demonstrating how different choosing different mesh parameters can lead to different meshes and different functionality based on the same initial user and garment data.

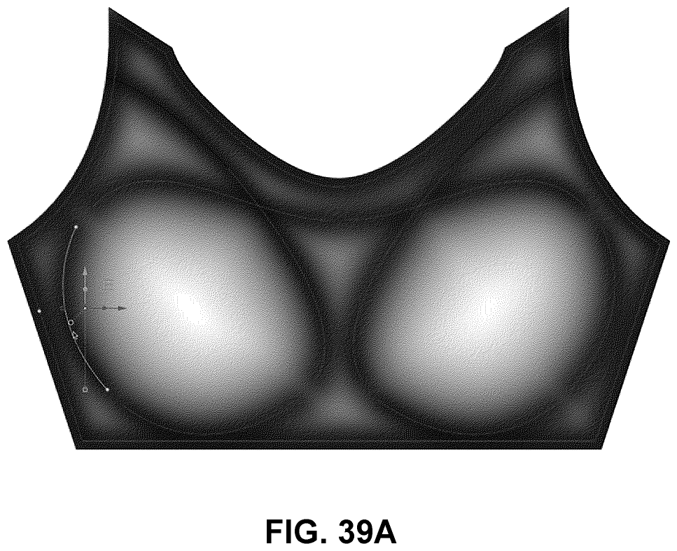

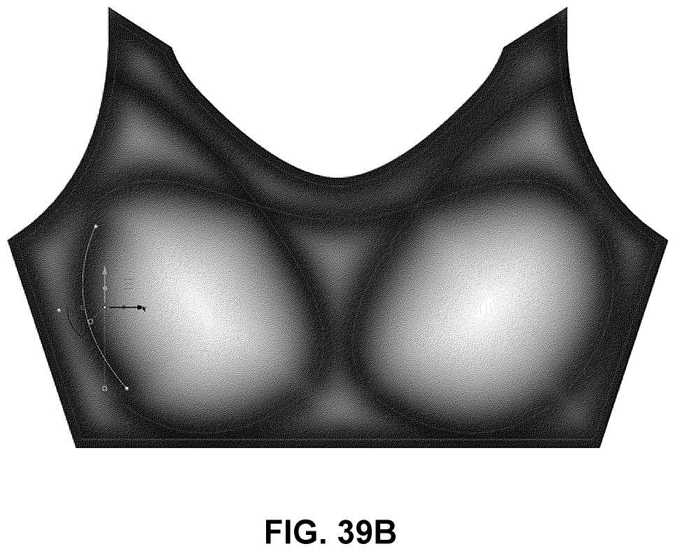

FIG. 39A and FIG. 39B show example visualizations of a garment pattern demonstrating the effect of moving an attractor curve on the resulting gradient. In both FIG. 39A and 39B, the same base garment pattern is used. Attractor curves may be modified by the user by dragging the attractor curves in the interface. Upon moving an attractor curve, the system 102 calculates the new gradient and updates the visualization. In FIG. 39A, the leftmost attractor curve is located close to the left side of the garment. In FIG. 39B, the leftmost attractor curve has been moved to the right, causing a new gradient to be calculated by the system.

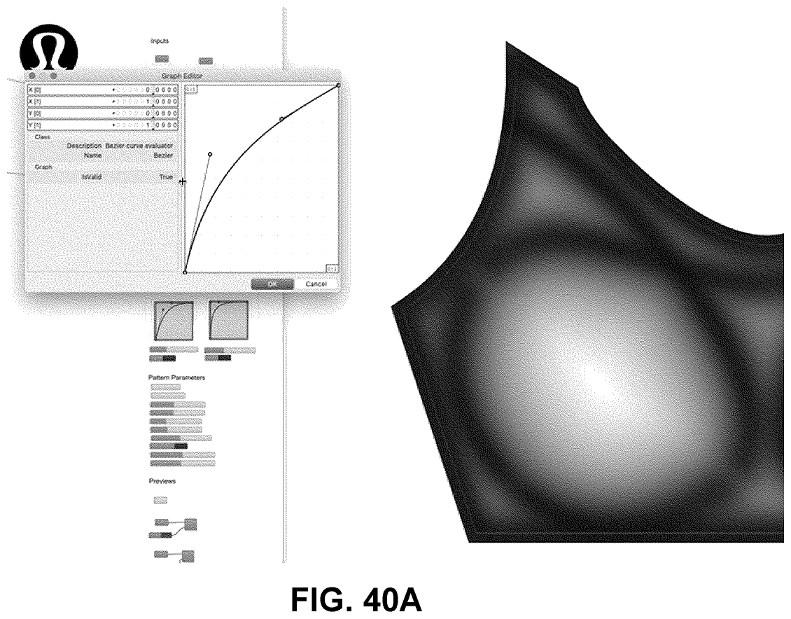

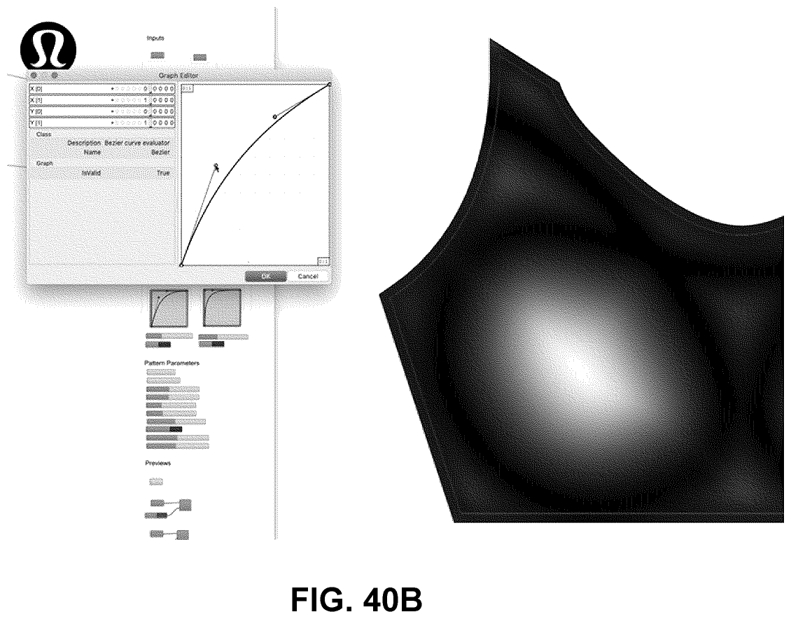

FIG. 40A and FIG. 40B show example visualizations of a garment pattern with a control panel of parameter controls including falloff controls demonstrating the effect of altering the falloff on the resulting gradient. In both FIG. 40A and FIG. 40B, the same base garment pattern is used. The system 102 updates the visualization in response to the customization data for the falloff curves. The dialog box on the left side of FIGS. 40A and 40B shows a falloff curve. In this example, the falloff curve is a Bezier curve, and the user can alter the curve by adjusting the control points. Upon altering the curve, the system 102 calculates the new gradient and the visualization of the garment pattern is updated to reflect the new falloff curve. In FIG. 40A, the gradient has a fairly rapid falloff close to attractor curves and a less rapid falloff further away. In FIG. 40B, one of the control points on the Bezier curve has been changed, causing the falloff to be less rapid close to the curve, and more rapid further away, as compared to FIG. 40A.

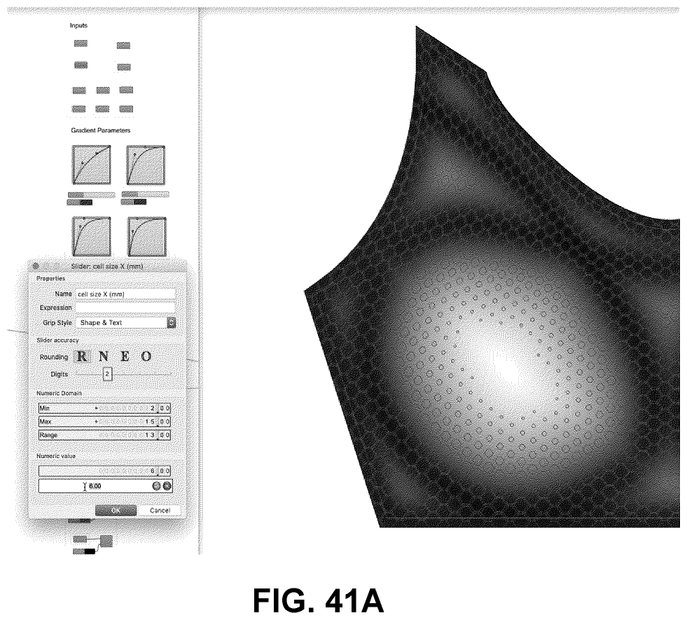

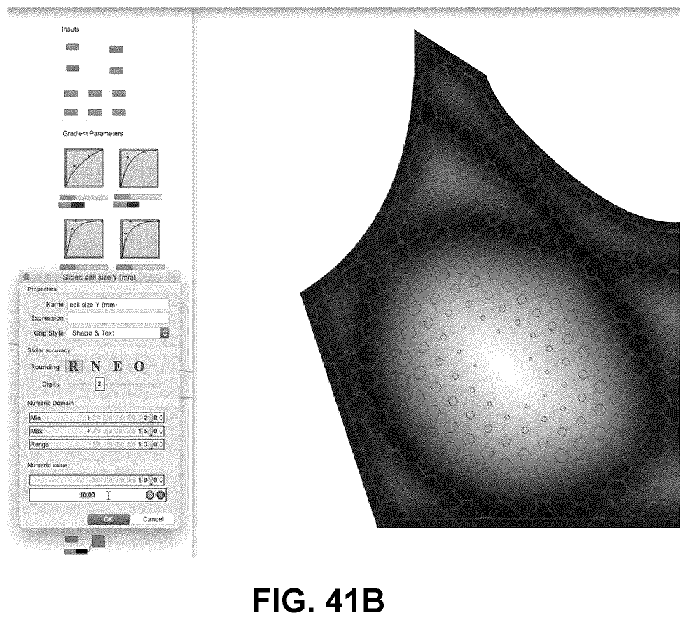

FIG. 41A and FIG. 41B show example visualizations of a garment pattern with a control panel of parameter controls including pattern parameter controls demonstrating the effect of altering the cell size on the resulting pattern. The system 102 updates the visualization in response to the customization data for the cell size. In both FIG. 41A and FIG. 41B, the same base garment pattern and gradient is used. The user can adjust the cell size parameters by using the dialogue box to input values. Upon entering parameters, the system 102 calculates the new grid and updates the visualization. In FIG. 41A, the base X cell size of the shapes is 6 mm. This results in a relatively dense grid pattern on the garment. In FIG. 41B, the base X cell size has been increased to 10 mm. This causes the grid pattern in FIG. 41B to made up of larger, less dense shapes than in FIG. 41A.

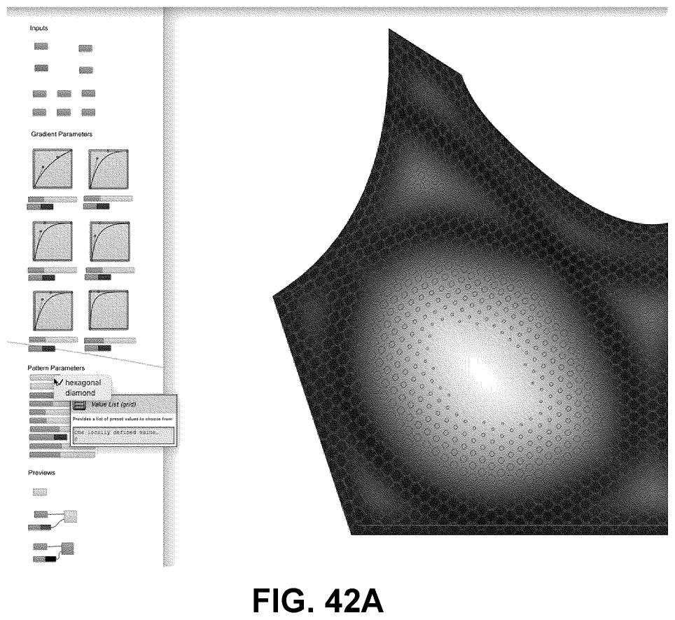

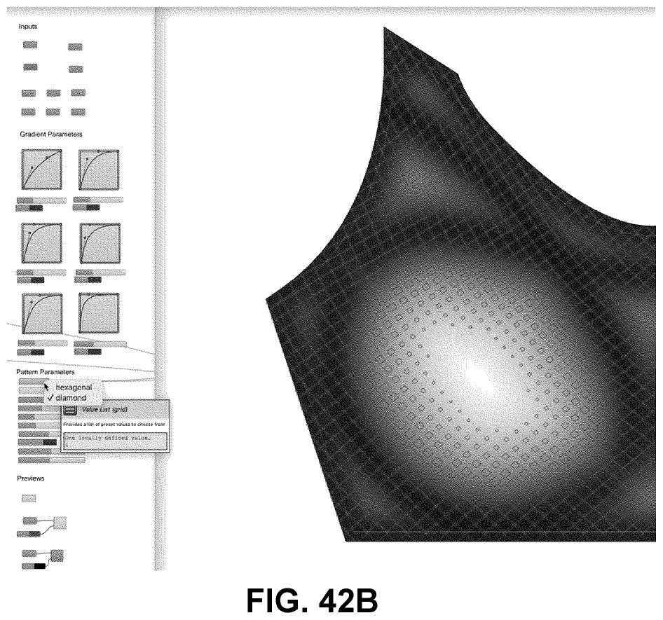

FIG. 42A and FIG. 42B show example visualizations of a garment pattern with a control panel of parameter controls including pattern parameter controls demonstrating the effect of altering grid type on the resulting pattern. The system 102 updates the visualization in response to the customization data for the grid type. In FIG. 42A and FIG. 42B, the same base garment pattern and gradient is used. In this example, the user can select the type of grid from a dropdown menu in the interface. Upon making a selection, the system 102 calculates the grid and updates the visualization In FIG. 42A, the user has selected a hexagonal grid. In FIG. 42B, the user has selected a diamond grid.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context. The term “and/or” herein when used in association with a list of items means any one or more of the items comprising that list.

While the disclosure has been described in connection with specific embodiments, it is to be understood that the disclosure is not limited to these embodiments, and that alterations, modifications, and variations of these embodiments may be carried out by the skilled person without departing from the scope of the disclosure.

It is furthermore contemplated that any part of any aspect or embodiment discussed in this specification can be implemented or combined with any part of any other aspect or embodiment discussed in this specification.

1. A system for providing an interface for product personalization, the system comprising:
non-transitory memory storing a database of pattern records, user records with measurement attributes from sensor data and user preference data, material records;
a hardware processor programmed with executable instructions for an interface having a control panel of tools with parameter controls for a parametric pattern to receive customization data to generate or modify a garment pattern, the interface displaying a visualization of the garment pattern generated or modified by the control panel of tools with parameter controls for the parametric pattern;
a hardware server coupled to the memory to access the database, the hardware server programmed with executable instructions to:
extract measurement and movement attributes from the sensor data to populate the user records in the database; collect user preference data to populate the user records in the database; generate or modify the garment pattern and associated code files by processing the extracted measurement and movement attributes, the user preference data, and the customization data from the interface having the control panel of tools with the parameter controls for the parametric pattern using the pattern records, the garment pattern and associated code files defining a perimeter pattern and a geometry of objects within the perimeter pattern, the user preference data comprising at least one of activity preference, fit preference, and feel preference, wherein the user preference data are aggregated with user physical data derived from the sensor data to drive parametric data for the garment pattern;
trigger the display of the visualization of the garment pattern at the interface using the associated code files and output of a modeling system;
receive additional customization data from the interface having the control panel of tools with the parameter controls for the parametric pattern;
modify the garment pattern and the associated code files using the additional customization data from the interface having the control panel of tools with the parameter controls for the parametric pattern;
trigger the update of the display of the visualization of the garment pattern at the interface in response to modification of the garment pattern and the associated code files using the additional customization data from the interface having the control panel of tools with the parameter controls for the parametric pattern;
a user device comprising one or more sensors for capturing the sensor data for the user, and a transmitter for transmitting the captured sensor data to the interface of the hardware processor or the hardware server over the network to personalize the product.

2. The system of claim 1, wherein the control panel of tools with the parameter controls for the parametric pattern comprises gradient parameter controls for modifying gradient parameters for the parametric pattern, and attractor curve parameter controls for modifying attractor curve parameters for the parametric pattern.

3. (canceled)

4. The system of claim 1, wherein the control panel of tools with the parameter controls for the parametric pattern comprises pattern parameter controls for modifying pattern parameters for the parametric pattern.

5. The system of claim 1, wherein the control panel of tools with the parameter controls for the parametric pattern comprises preview parameter controls for modifying preview parameters for the parametric pattern.

6. The system of claim 1, wherein the garment pattern is for a bra, wherein the user data comprises breast movement data, and the extracted measurement and movement attributes comprise side to side acceleration, up and down acceleration, displacement and angle of peak acceleration, wherein the sensor data comprises breast sensor data, wherein the hardware processor calibrates and filters signals from the breast sensor data and detects peaks and strides in the signals, wherein the measurement and movement attributes comprise magnitude, resultant, resultant angle, wherein the hardware processors uses the magnitude to compute gradient metrics, uses the resultant to select movement group for a support pattern, and uses the resultant angle to apply gradient support, wherein the hardware processor computes the gradient metrics using the user preference data, wherein the hardware processor computes a baseline gradient using a product pattern piece, and a final gradient using the baseline gradient, the gradient metrics, the gradient support, and the support pattern.

7. (canceled)

8. (canceled)

9. (canceled)

10. (canceled)

11. The system of claim 1, wherein the user data comprises movement data captured by the sensors, and the extracted measurement and movement attributes comprise side to side acceleration, up and down acceleration, displacement and angle of peak acceleration, wherein the hardware server generates or modifies the garment pattern and the associated code files using the pattern records by selecting a base pattern for the garment and a base gradient, and optimizing the base pattern for the garment and the base gradient for a desired outcome, and by adjusting the base pattern for the garment and the base gradient using the extracted measurement and movement attributes and the user preference data.

12. (canceled)

13. (canceled)

14. The system of claim 1, wherein the control panel of tools with the parameter controls for the parametric pattern comprises shape, size, falloff rate and interaction parameter controls, wherein the hardware server generates or modifies the garment pattern and the associated code files using the pattern records by selecting a base pattern for the garment and a base gradient, and optimizing the base pattern for the garment and the base gradient for a desired outcome by optimizing shape, size, falloff rate and interaction parameters based on input from the shape, size, falloff rate and interaction parameter controls.

15. The system of claim 1, wherein the hardware server generates or selects a base pattern using generative design models processing the user data, the base pattern for generating or modifying the garment, wherein the hardware server updates the generative design models based on feedback data on the product.

16. The system of claim 1, wherein the hardware server transmits manufacturing instructions for the product in response to receiving purchase instructions at the interface.

17. (canceled)

18. The system of claim 1, wherein the hardware server generates the product and associated code files by generating bill of material files, and assembling content files.

19. (canceled)

20. The system of claim 1, wherein the interface receives a modification request for the product and wherein the hardware server updates the product and the associated code files based on the modification request.

21. The system of claim 1, wherein the user device captures the sensor data from a plurality of data sources, the sensor data defining physical or behavioural characteristics of the user by video data or audio data, wherein the user device connects to or integrates with an immersive hardware device that captures audio data, the image data and data defining additional physical or behavioural characteristics of the user as of the sensor data, wherein the attributable database comprises simulated garment records, wherein the hardware server generates simulated product options as part of the product and associated code files, and wherein the interface displays a visualization of the simulated product options, wherein the simulated product options comprise at least one of soft body physics simulation, hard body physics simulation, static 3D viewer and AR/VR experience content.

22. The system of claim 1, wherein the hardware server generates measurement metrics using at least one of 3D scanning, machine learning prediction, user measuring, and garment measuring.

23. The system of claim 1, wherein the hardware server generates movement metrics based inertial measurement unit (IMU) data, computer vision, pressure data, and radio-frequency data.

24. The system of claim 1, wherein the hardware server extracts the user attributes from user data comprising at least one of purchase history, activity intent, interaction history, and review data for the user.

25. The system of claim 1, wherein the hardware server generates perceptual preference metrics based on at least one of garment sensation, preferred handfeel, thermal preference, and movement sensation, wherein the hardware processor computes a preferred sensory state as part of extracted user attributes.

26. The system of claim 1, wherein the hardware server generates emotional signature metrics based on at least one of personality data, mood state data, emotional fitness data, personal values data, goals data, and physiological data, wherein the emotional signature metrics comprise social signature metrics, connectedness metrics, or resonance signature metrics, wherein the emotional signature metrics are used to populate at least some data for the garment pattern, wherein the hardware server is configured to determine an emotional signature of one or more additional users; determine users with similar emotional signatures; predict connectedness between users with similar emotional signatures; and generate the product using data corresponding to the users with similar emotional signatures.

27. (canceled)

28. (canceled)

29. (canceled)

30. (canceled)

31. (canceled)

32. The system of claim 1, wherein the interface can transmit another product request, and the hardware server is configured to provide an additional visualization for another product for in response to the other product request.

33. Non-transitory computer-readable medium storing instructions that, when executed by a hardware processor, cause the hardware processor to perform operations comprising:
extracting measurement attributes from sensor data to populate the user records in the database, the sensor data captured by sensors;
collecting user preference data to populate the user records in a database, the user preference data comprising at least one of activity preference, fit preference, and feel preference, wherein the user preference data are aggregated with user physical data derived from the sensor data to generate parametric data, the database storing pattern records, user records with measurement attributes from the sensor data and user preference data, material records, and generative design models in memory;
in response to a product request and customization data from an interface having a control panel of tools with parameter controls for a parametric garment pattern to receive the customization data, generate or modify the pattern and associated code files by processing the extracted measurement attributes, the parametric data, and the customization data;
displaying a visualization of a product at the interface with a selectable purchase option;
receiving additional customization data from the control panel of tools at the interface; and
updating the visualization of the product at the interface in response to the additional customization data from the control panel of tools.

34. A computer implemented method for personalization of a product, the method comprising:
storing a database of pattern records, user records with measurement attributes from sensor data and user preference data, material records, and generative design models in memory;
capturing sensor data for a user by sensors;
extracting measurement attributes from the sensor data to populate the user records in the database;
collecting user preference data to populate the user records in the database, the user preference data comprising at least one of activity preference, fit preference, and feel preference, wherein the user preference data are aggregated with user physical data derived from the sensor data to generate parametric data;
in response to a product request and customization data from an interface having a control panel of tools with parameter controls for a parametric garment pattern to receive the customization data, generating or modifying the pattern and associated code files by processing the extracted measurement attributes, the parametric data, and the customization data;
displaying a visualization of a product at the interface with a selectable purchase option;
receiving additional customization data from the control panel of tools at the interface; and
updating the visualization of the product at the interface in response to the additional customization data from the control panel of tools.

35. (canceled)

36. (canceled)

37. (canceled)

38. (canceled)

39. (canceled)

40. (canceled)

41. (canceled)
